(19) United States
(12) Patent Application Publication
(10) Pub. No.: US 2026/0267975 A1
(43) Pub. Date: Sep. 10, 2026

(54) SYSTEM AND METHOD FOR DETECTING MALWARE BY REVERSE ENGINEERING BINARY DATA IN A DISTRIBUTED NETWORK

(71) Applicant: Booz Allen Hamilton Inc., McLean, VA (US)

(72) Inventor: Dakota Eugene Palmer, Elkridge, MD (US)

(73) Assignee: Booz Allen Hamilton Inc., McLean, VA (US)

(21) Appl. No.: 19/074,898

(22) Filed: Mar. 10, 2025

(51) Int. Cl. G06F 21/56

(52) U.S. Cl. CPC G06F 21/56

(57) ABSTRACT

Provided are methods and systems for detecting malware in a computer network, including plural agent computing nodes; a controller node for synchronizing the plural agent computing nodes for reverse engineering binary data; and a malware detection node including a processor configured to communicate with memory and execute program code for a malware detection application. The processor can receive a binary data stream and text data input and distribute the binary data and the at least one conditional attribute to each of the plural agent computing nodes. The plural agent computing nodes can generate a source code file. The controller node can determine that a first source code file generated by a first agent processor, when executed by the first agent processor on a first agent computing node, satisfies the at least one conditional attribute and share the first source code file and the validated attribute with the plural agent nodes.

### CROSS-REFERENCE

This U.S. Patent Application is related to U.S. Patent Application entitled “SYSTEM AND METHOD FOR DETECTING MALWARE BY REVERSE ENGINEERING BINARY DATA” and filed under Attorney Docket No. 1003918-001152, the entire contents of which are incorporated herein by reference.

### FIELD

The subject matter disclosed relates generally to computer implementations of a reverse engineering network and automatic analysis of binary data, and, in some embodiments, to methods, systems, and non-transitory computer readable mediums encoded with program code for detecting malware within a computer network based on reverse engineering and analyzing of binary data using a distributed network of agent nodes.

### BACKGROUND INFORMATION

Typically, reverse engineering of binary files, such as malware samples, is extremely resource intensive, draining both time and computing resources for minimal progress in reverse engineering tasks, such as reverse engineering a malware sample. Additionally, specialized knowledge and skill can be required for analyzing and reverse engineering binary files, including time-intensive manual analysis of the binary files and binary data therein. Similarly, time-intensive manual testing of any potentially reverse engineered program code can consume both time and computing resource, while high quality and/or positive results cannot be achieved.

In some instances, reverse engineering binary data requires highly skilled analysts to manually analyze binary files, reconstruct functionality of the binary files, and develop tools to interact with the binary files. This process can take days or weeks per binary file, and manual analysis cannot provide a comprehensive analysis to collect all information related to the binary file. Without high quality results and efficient reverse engineering, malicious program code such as malware can evolve faster than malicious program samples can be analyzed, allowing the malicious program code to avoid detection when infiltrating a computing network.

### SUMMARY

Embodiments may relate to a system for detecting malware in a computer network. The system can include plural agent computing nodes each including an agent processor in communication with an agent memory storing program code for an adaptive reverse engineering application. The system can also include a controller node including a controller processor executing program code for controlling the plural agent computing nodes. The system can include a malware detection node including a processor for synchronizing the plural agent computing nodes for reverse engineering binary data. The processor can be configured to communicate with the memory and execute program code for a malware detection application. The program code for the malware detection application, when executed, can cause the processor to receive a binary data stream and text data input. The text data input can define at least one conditional attribute for reverse engineering the binary data. The program code for the malware detection application, when executed, can cause the processor to distribute the binary data and the at least one conditional attribute to each of the plural agent computing nodes. The program code for the adaptive reverse engineering application on each of the plural agent nodes, when executed by the agent processors, can cause the agent processors to generate a source code file based on reverse engineering the binary data stream. The program code for controlling the plural agent computing nodes, when executed by the controller processor, can cause the controller node to determine that a first source code file generated by a first agent processor, when executed by the first agent processor on a first agent computing node, satisfies the at least one conditional attribute to generate a validated attribute. The program code for controlling the plural agent computing nodes, when executed by the controller processor, can cause the controller node to share the first source code file and the validated attribute with each of the other plural agent nodes and the controller node.

Embodiments may relate to a method for detecting malware in a computer network. The method can include receiving a binary data stream of binary data representing a malware file at a controller node. The method can also include transmitting the binary data stream to plural agent nodes in communication with the controller node. The method can include automatically reverse engineering the binary data stream at each agent node of the plural agent nodes to collect data about the binary data stream among the plural agent nodes. The method can also include generating a report for the binary data stream at each agent node from the collected data. The method can include determining, at a controller node, that the report satisfies a conditional attribute. The method can also include distributing the report to each of the plural agent nodes to update the collected data about the binary data stream such that the collected data at each agent node satisfies the conditional attribute. The method can include generating a reverse engineered script file at each agent node based on the report. The method can also include executing the reverse engineered script file to intercept a malware beacon transmission within the computer network.

Embodiments may relate to a system for detecting malware in a computer network. The system can include a memory storing program code for a reverse engineering application. The system can also include a database storing conditional attributes defining successful decompiling of binary program code. The system can include plural agent nodes each including an agent processor and an agent memory storing program code for an agent reverse engineering application. The system can also include a controller node in communication with the plural agent nodes. The system can include a malware detection node including a processor for decompiling binary program code configured to communicate with the memory storing program code for the reverse engineering application. The program code for the reverse engineering application, when executed, can cause the processor to receive a binary file including binary program code. The program code for the reverse engineering application, when executed, can cause the processor to receive text input data which defines a goal of reverse engineering the binary file. The program code for the reverse engineering application, when executed, can cause the processor to automatically decompose the text input data into one or more conditional attributes for validating a task associated with reverse engineering the binary file. The program code for the reverse engineering application, when executed, can cause the processor to transmit the binary file and the one or more conditional attributes to each agent node. The program code for the reverse engineering application, when executed, can cause the processor to receive and execute a final validated source code file to intercept a malware beacon transmission within the computing system. The program code for the agent reverse engineering application on each agent node, when executed, can cause each agent processor to iteratively generate a processor trace output by executing the binary file while tracing instructions of the processor. The program code for the agent reverse engineering application on each agent node, when executed, can cause each agent processor to iteratively map the processor trace output to decompiled code output to generate a source code file based on the binary file. The program code for the agent reverse engineering application on each agent node, when executed, can cause each agent processor to iteratively determine a validated source code file such that the source code file satisfies at least one conditional attribute of the one or more conditional attributes. Program code for the controller node, when executed, can cause the controller node to transmit the validated source code file to each of the agent nodes to update the source code file to a validated source code file on each agent node. The program code for the controller node, when executed, can cause the controller node to terminate iterative execution of each agent reverse engineering application to generate the final validated source code file based on determining that all of the one or more conditional attributes are satisfied. The program code for the controller node, when executed, can cause the controller node to cause an agent node to transmit the final validated source code file to the malware detection node for intercepting a malware beacon transmission.

### BRIEF DESCRIPTION OF THE DRAWINGS

Other objects and advantages of the present disclosure will become apparent to those skilled in the art upon reading the following detailed description of exemplary embodiments, in conjunction with the accompanying drawings, in which like reference numerals have been used to designate like elements, and in which:

FIG. 1 is a diagram of an exemplary system configuration for detecting malware in a computer network and/or reverse engineering binary data as disclosed herein;

FIG. 2 is a flow diagram of an exemplary method for detecting malware in a computer network and/or reverse engineering binary data using a distributed network as disclosed herein;

FIG. 3 is a diagram of an exemplary computing and/or network environment in which methods, systems, and/or computer program products, described herein, can be implemented as disclosed herein;

FIG. 4 is a diagram of an exemplary distributed architecture for reverse engineering binary data as disclosed herein;

FIG. 5 is a diagram of an exemplary system components and processing flow for reverse engineering binary data using a distributed network as disclosed herein; and

FIG. 6 is a diagram of exemplary components of a computing device and/or system as disclosed herein.

### DETAILED DESCRIPTION

In accordance with exemplary embodiments, specially configured computing systems (e.g., having specially configured processors) can be used for reverse engineering binary data (e.g., malicious program code samples) to collect and store data related to the binary data for subsequent detection of execution of that binary data within a computer network. Embodiments can enhance a reverse engineering process by automatically analyzing the binary data, including analysis of processor traces, decompiled code, function addresses and function boundaries, and analysis of test execution of the binary data and/or analysis of test execution of generated scripts. The generated scripts can be created to simulate or emulate functions of the binary data (e.g., a command and control server for a malware sample) such as functional communications and message transmission.

According to some embodiments, specially configured computing systems programmed to automatically reverse engineer binary data and/or detect malware using a network of plural agent nodes can reduce time, effort, and computational resources required for reverse engineering the binary data to gain valuable data and signatures associated with the binary data sample (e.g., malware sample). For example, embodiments can greatly reduce the time required to analyze and reverse engineer a malware sample such that the malware sample can be detected and live communications to/from the malware sample can be subsequently intercepted in real time. Embodiments disclosed herein can reduce time and resources required for analyzing and/or reverse engineering binary data by implementing plural agent nodes using a breakthrough sharing architecture, as described herein. Such embodiments can also efficiently and effectively build a database of network attributes and/or signatures of various binary data samples, including malicious binary data samples, through automatic analysis and reverse engineering within the plural agent nodes. Thus, embodiments do not require intensive manual analysis of binary data and/or compiled code, which is difficult to read and interpret, even for experienced professionals. Accordingly, embodiments can also efficiently and effectively automate development of analysis and/or testing tools to test binary data or generated scripts across the various agent nodes, reducing time and computing resources, and increasing the accuracy of reverse engineered binary data samples. Such automatic development of analysis and/or testing tools based on automated reverse engineering tasks has not been previously accomplished.

As such, disclosed embodiments address an important challenge in cybersecurity: a time-intensive and resource-heavy process of reverse engineering binary files and malware samples for identifying and detecting live malware. Embodiments can dynamically generate functional communication scripts based on results of analyzing binary data. Embodiments can also provide an automated milestone-based approach that breaks complex analysis tasks into manageable subtasks, including conditional attributes that can be validated by the computing system analyzing the binary data. Embodiments can provide comprehensive understanding of binary data by leveraging integration of processor trace output with decompiled code analysis, distributing the analysis across multiple agent nodes using synchronization of breakthroughs. Thus, embodiments can significantly reduce analysis time, enable parallel processing of multiple binary data samples across the multiple agent nodes, and produce and maintain high-quality results that can be quickly shared among the agent nodes to increase efficiency of reverse engineering tasks. Disclosed embodiments address both scalability and efficiency problems in current reverse engineering practices while reducing time and resource requirements required for analysis. In this way, disclosed embodiments reducing computing resources and time required for binary data analysis can allow for more effective and efficient detection of malware within a computing network.

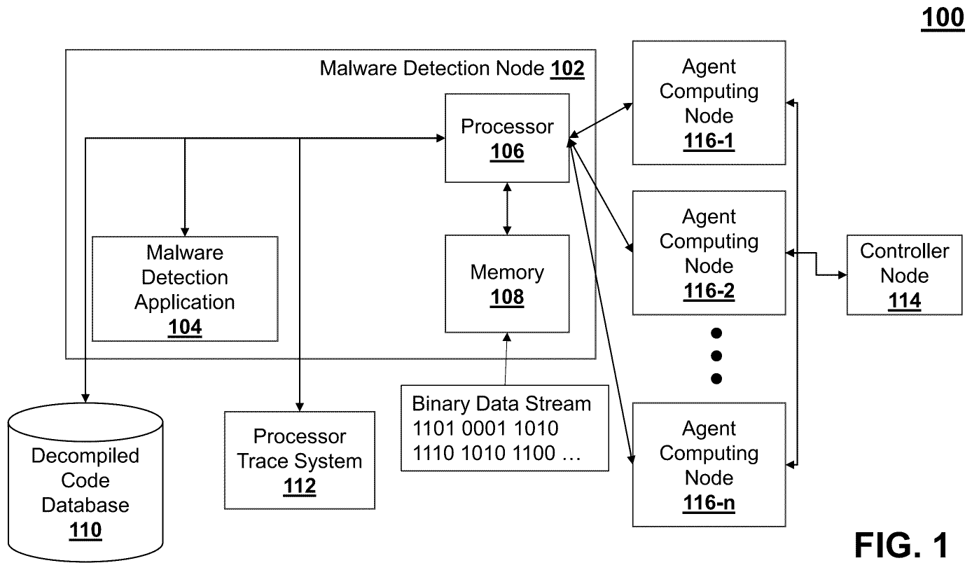

FIG. 1 shows a diagram of an exemplary system configuration for detecting malware in a computer network as disclosed herein. The various components of FIG. 1 can be implemented in and/or processed by a specially configured processor (e.g., a CPU) and/or on any number of specially configured distributed processors (e.g., a distributed and/or decentralized computing system) coupled with memory and connected via a communications network. Each of the components shown in FIG. 1 are described in the context of an exemplary embodiment.

As shown in FIG. 1, embodiments relate to a computing system 100 configured for detecting malware in a computer network. In some embodiments, computing system 100 can be specially configured for reverse engineering binary data and/or detecting malware in a computer network using distributed nodes. Computing system 100 can include malware detection node 102, malware detection application 104, processor 106, memory 108, decompiled code database 110, processor trace system 112, controller node 114, and agent computing node 116-1 to agent computing node 116-n (referred to individually as agent computing node 116 and collectively as agent computing nodes 116 where appropriate). As shown in FIG. 1, controller node 114 and/or agent computing nodes 116 can be included in computing system 100. In some embodiments, controller node 114 and/or agent computing nodes 116 can be separate from computing system 100. In some embodiments, controller node 114 and/or agent computing nodes 116 can be can be included as part of computing system 100, such as in an instance where a reverse engineered binary data file in a form of a script and/or decompiled program code is executed on computing system 100 and/or malware detection node 102 to identify a malware beacon (e.g., where the script file and/or decompiled program code is executed to simulate/emulate malware code that may have been included in the binary data file). Computing system 100 can be configured for reverse engineering binary data (e.g., a malware sample) and detecting malware in a computer network based on the reverse engineered and/or analyzed binary data.

Computing system 100 can be configured for detecting malware in a computer network using distributed agent nodes. Computing system 100 can include at least one computing node (e.g., malware detection node 102) and plural agent computing nodes (e.g., agent computing node 116) each including an agent processor in communication with an agent memory storing program code for an adaptive reverse engineering application. Computing system 100 can also include a controller node (e.g., controller node 114) including a controller processor executing program code for controlling the plural agent computing nodes. Computing system 100 can include a malware detection node (e.g., malware detection node 102) including a processor (e.g., processor 106) for synchronizing the plural agent computing nodes for reverse engineering binary data. The processor can be configured to communicate with memory (e.g., memory 108) and execute program code for a malware detection application (e.g., malware detection application 104).

The program code for the malware detection application, when executed, can cause the processor to receive a binary data stream and text data input. For example, processor 106 can execute malware detection application 104 to receive a binary data stream and text data input. The binary data stream can be received at memory 108 for access by processor 106 or the binary data stream can be received at processor 106. The text data input can be received at memory 108 for access by processor 106 or the text data input can be received at processor 106. In some embodiments, processor 106 can receive the binary data stream as a binary file including binary data. For example, the binary data stream can include a malware sample and/or a malware file. The text data input can define at least one conditional attribute for reverse engineering the binary data.

The program code for the malware detection application, when executed, can cause the processor to distribute the binary data and the at least one conditional attribute to each of the plural agent computing nodes. For example, processor 106 can distribute the binary data and the at least one conditional attribute to each of the plural agent computing nodes for analysis of the binary data and validation of the at least one conditional attribute. Each of the plural agent computing nodes can analyze the binary data to each generate a source code file (e.g., a script) and each of the plural agent computing nodes can validate the source code files against the at least one conditional attribute independently. In this way, where each plural agent computing node generates a different source code file based on analyzing the binary data, each plural agent computing node can separately validate its own source code file against the at least one conditional attribute. In some embodiments, where a first agent node validates a generated source code file against at least one conditional attribute, that first agent node can share the generated source code file and validation results with each of the other plural agent nodes. This allows the plural agent nodes to share breakthroughs in reverse engineering the binary data amongst each other to speed up the reverse engineering process and efficiently arrive at a solution.

The program code for the adaptive reverse engineering application on each of the plural agent nodes (e.g., in the agent memories), when executed by the agent processors, can cause the agent processors to generate a source code file based on reverse engineering the binary data stream. For example, each of plural agent nodes 116 can generate a source code file based on reverse engineering the binary data stream using various tools, such as a processor trace (e.g., via processor trace system 112), a decompilation tool (e.g., Ghidra), or other code analysis tools. In some embodiments, each agent node 116 can execute the binary data received in the binary data stream to identify a network attribute of the binary data stream.

The program code for controlling the plural agent computing nodes, when executed by the controller processor, will cause the controller node to determine that a first source code file generated by a first agent processor, when executed by the first agent processor on a first agent computing node, satisfies the at least one conditional attribute to generate a validated attribute. For example, controller node 114 can determine that a first source code file generated by a first agent processor (e.g., on a first agent node 116-1), when executed by the first agent processor on first agent computing node 116-1, satisfies the at least one conditional attribute. First agent computing node 116-1, when determining that the first source code file satisfies the at least one conditional attribute, can generate a validated attribute. The validated attribute may be separately extracted from the source code file and included in validation results for sharing with other agent computing nodes 116. In some embodiments, first agent computing node 116-1 can share the source code file with other agent computing nodes 116 via controller node 114.

The program code for controlling the plural agent computing nodes, when executed by the controller processor, will cause the controller node to share the first source code file and the validated attribute with each of the other plural agent nodes and the controller node. For example, controller 114 can share the first source code file and the validated attribute (e.g., validated results and/or validated source code file) with each of the other plural agent nodes and the controller node. In this way, a breakthrough found by at least one agent computing node 116 can be shared with other plural agent computing nodes 116 via controller node 114. Sharing of the validated attribute allows agent computing nodes 116 to share progress amongst agent computing nodes 116 where other agent computing nodes 116 did not similarly validate the at least one conditional attribute. In some embodiments, separate agent computing nodes 116 can separately validate different conditional attributes and share the separate validated attributes (e.g., validated results) amongst other agent computing nodes 116. Thus, agent computing nodes 116 can divide reverse engineering tasks between agent computing nodes 116 to reduce time and resources required to reverse engineer the binary data stream.

The program code for the adaptive reverse engineering application on each of the plural agent computing nodes, when executed, can cause the plural agent nodes to execute a processor trace on the binary data stream to dump processor trace data to the agent memory using the program code for the processor trace system. For example, agent computing nodes 116 can execute a processor trace on the received binary data stream using processor trace system 112. Agent computing nodes 116 can call processor trace system 112 using an application programming interface (API) while executing the binary data stream to execute a processor trace on the received binary data stream. Agent computing nodes 116 can then dump processor trace data received from processor trace system 112 to agent memory for analysis. Processor trace data can include one or more data packets including recorded information for execution flow of the binary data stream on agent processors, information for which instructions were executed, information for when and/or in what order instructions were executed, and information on whether conditional branches were executed. In this way, the processor trace data can allow for step-by-step execution analysis of the binary data stream on agent computing nodes 116.

The program code for the adaptive reverse engineering application on each of the plural agent computing nodes, when executed, can cause the agent processors to identify a network attribute associated with the binary data stream based on the processor trace data. For example, agent processors of agent computing nodes 116 can identify a network attribute associated with the binary data stream based on the processor trace data. Agent processors can identify a network attribute found within the binary trace data. A network attribute can include an internet protocol (IP) address, a cryptographic key used to encrypt a message within the binary data stream, a port number, a transport protocol, a cryptographic library, or a hypertext transfer protocol (HTTP) certificate. In some embodiments, a network attribute can include any information regarding transmission of information within the binary data stream. Where the binary data stream represents a malware sample and/or a malware file, the network attribute can include information about transmission of the malware, a malware beacon, and/or the like.

The program code for the adaptive reverse engineering application on each of the plural agent computing nodes, when executed, can cause the agent processors to extract the network attribute from the binary data stream. For example, agent processors on agent computing nodes 116 can extract the network attribute from the binary data stream based on identifying the network attribute from the processor trace data. Agent processors can extract the network attribute from the binary data stream and store the network attribute in decompiled code database 110, share the network attribute with each other agent computing node 116, and/or transmit the network attribute to malware detection node 102 and/or memory 108 for later use in detecting malware.

The program code for the adaptive reverse engineering application on each of the plural agent computing nodes, when executed, can cause the agent processors to generate a script (e.g., a source code file) for identifying and intercepting a beacon transmission used to transmit malware data. The script can be generated based on the network attribute. For example, agent processors of agent computing nodes 116 can each generate a script for identifying and intercepting a beacon transmission used to transmit malware data. In some embodiments, only some of the scripts generated by agent computing nodes 116 can identify and intercept a beacon transmission because those scripts satisfied the at least one conditional attribute, while other scripts do not satisfy the at least one conditional attribute. In such an instance, agent computing node 116 that generated the script satisfying the at least one conditional attribute can share the script (e.g., the breakthrough) with each other agent computing node 116 so that each agent computing node 116 has the latest and most reverse engineered version of the binary data (e.g., the script satisfying the at least one conditional attribute).

Agent processors of agent computing nodes 116 can generate the script based on the network attribute, by generating a script that can exhibit a functional communication of malware (or other malicious program code) using the network attribute related to the binary data. In some embodiments, agent processors of agent computing nodes 116 can generate the script from reverse engineering the binary data stream, such that the script is a close representation of decompiled program code corresponding to the binary data stream. In some embodiments, agent processors 116 can generate the script from the processor trace data of the binary data stream, such that the script represents decompiled program code corresponding to another component or program related to the binary data stream. For example, where the binary data stream represents a malware sample and/or malware code, agent processor of agent computing nodes 116 can generate the script such that the script represents decompiled program code for a command and control component (e.g., a command and control server/device) that is related to the malware sample and/or the malware code. In some embodiments, the script can include functional communication aspects of the binary data stream and/or malware sample. In some embodiments, agent processors of agent computing nodes 116 and malware detection node 102 can use information and/or data obtained while reverse engineering the binary data stream to develop additional scripts representing tools (e.g., software tools) to further analyze and/or reverse engineer the binary data stream.

The program code for the malware detection application, when executed, can cause the processor to intercept reception of the beacon transmission and malware data within the computer network. For example, processor 106 can intercept reception of the beacon transmission and malware data within the computer network by executing the generated script or based on executing the generated script received from agent computing nodes 116. In some embodiments, processor 106 can intercept reception of the beacon transmission and malware data within the computer network by executing the generated script where the generated script represents a command and control component of malware. Processor 106 can execute the generated script to cause transmission of a malware beacon to malware detection node 102. In this way, the reverse engineered binary data stream can provide information on malicious code by simulating a component (e.g., a command and control component) of malware code to transmit a beacon and intercept and analyze the transmitted beacon.

In some embodiments, the program code for the malware detection application, when executed, can cause the processor to execute the script to identify the beacon transmission. For example, processor 106 can execute the script to identify the beacon transmission. In some embodiments, processor 106 can execute the script to emulate the beacon transmission from a command and control server. In some embodiments, processor 106 can execute the script to extract more information (e.g., network attributes) from the script to obtain more information for reverse engineering the binary data stream and/or to obtain more information about the binary data stream or malware file. The additional information obtained from the script can be stored in decompiled code database 110.

In some embodiments, the program code for the malware detection application, when executed, can cause the processor to store data for the beacon transmission and the network attribute in a database for detection of the beacon transmission within the computer network. For example, processor 106 can store data for the beacon transmission and the network attribute in decompiled code database 110 for detection of the beacon transmission within the computer network. Processor 106 can store the network attribute to identify the beacon transmission, or other information, as a beacon identifier stored in decompiled code database 110. A beacon identifier can include any piece of information (e.g., a network attribute) relating to the binary data stream (e.g., malware file, a command and control device, etc.) or the transmission of a malware beacon.

In some embodiments, the program code for the adaptive reverse engineering application on each of the plural agent computing nodes, when executed, can cause the agent processors to generate decompiled program code based on the binary data stream. For example, agent processors on agent computing nodes 116 can generate decompiled program code based on the binary data stream using a code decompiling tool and/or software reverse engineering tool. The binary data stream can include compiled program code (e.g., machine code, machine-readable code, an executable file, and/or the like).

In some embodiments, the adaptive reverse engineering application on each of the plural agent computing nodes, when executed, can cause the agent processors to identify a first offset and a last offset for each of plural functions in the processor trace data. For example, agent processors on agent computing nodes 116 can identify a first offset and a last offset for each of plural functions in the processor trace data. The processor trace data can include one or more functions identified by processor trace system 112 which were executed by the agent processors as part of executing the processor trace. The one or more functions can be represented by compiled code in the binary data stream and/or the one or more functions can be represented by program code (e.g., decompiled program code, human-readable program code, source code, and/or the like) in the processor trace data and/or the generated script.

In some embodiments, the program code for the adaptive reverse engineering application on each of the plural agent computing nodes, when executed, can cause the agent processors to correlate the first offset and the last offset of each of the plural functions to the decompiled program code. For example, agent processors on agent computing nodes 116 can correlate the first offset and the last offset of each of the plural functions to the decompiled program code. The first offset can indicate a position in the binary data stream, relative to the processor trace data, in which a particular function began execution, or where the particular function was entered. The last offset can indicate a position in the binary data stream, relative to the processor trace data, in which a particular function terminated execution, or where the particular function was exited. In this way, entry and exit points of the plural functions can be mapped to the decompiled program code of the binary data stream to align function position and/or order of execution to the decompiled program code such that an improved structure of source code for the binary data stream can be viewed, tested, and further reverse engineered. Thus, malware detection node 102 and/or agent computing nodes 116 can use the mapped processor trace and decompiled program code to more effectively reverse engineer the binary data and generate scripts that simulate/emulate the binary data stream, e.g., scripts that use similar functions and similar order of execution that was determined when mapping the processor trace data to the decompiled program code.

In some embodiments, the program code for the malware detection application, when executed, can cause the processor to identify a malware beacon identifier using the first source code file. For example, the program code for malware detection application 104 can cause processor 106 to identify a malware beacon identifier using the first source code file transmitted from agent computing nodes 116. The program code for the malware detection application, when executed, can cause the processor to store the malware beacon identifier in the malware database. For example, the program code for malware detection application 104 can cause processor 106 to store the malware beacon identifier in decompiled code database 110 and/or another database. The program code for the malware detection application, when executed, can cause the processor to intercept a malware beacon transmission within the computer network by identifying the malware beacon transmission based on the malware beacon identifier. For example, the program code for malware detection application 104 can cause processor 106 to intercept a malware beacon transmission within the computer network (e.g., computing device 100) by identifying the malware beacon transmission based on the malware beacon identifier. The malware beacon identifier can include a network attribute defined by the source code file generated by synchronization of agent computing nodes 116, or a network attribute present in the binary data stream.

In some embodiments, computing system 100 can include a processor trace system. For example, computing system 100 can include processor trace system 112. The program code for the controller node, when executed, can cause the controller node to direct each agent processor on each of the plural agent computing nodes to execute a processor trace on the binary data stream. For example, controller node 114 can direct (e.g., cause, via a command) each agent computing node 116 to execute a processor trace on the binary data stream by making API calls to processor trace system 112.

In some embodiments, the program code for the adaptive reverse engineering application on the plural agent nodes, when executed by the agent processors, can cause the agent processors to transmit an API request to the processor trace system to execute a processor trace on the binary data stream. For example, the program code for the adaptive reverse engineering application on agent computing nodes 116, when executed by the agent processors, can cause the agent processors of agent computing nodes 116 to transmit an API request to processor trace system 112 requesting a processor trace on the binary data stream at each agent computing node 116.

In some embodiments, the program code for the adaptive reverse engineering application on the plural agent nodes, when executed by the agent processors, can cause the agent processors to dump processor trace data to each agent memory. For example, the program code for the adaptive reverse engineering application on agent computing nodes 116, when executed by the agent processors, can cause the agent processors of agent computing nodes 116 to dump processor trace data to each agent memory of each agent computing node 116 once the processor trace has been executed (e.g., by calling processor trace system 112).

In some embodiments, the program code for the adaptive reverse engineering application on the plural agent nodes, when executed by the agent processors, can cause the agent processors to map the processor trace data to decompiled code data from a decompiled code database to generate the source code file based on reverse engineering the binary data stream. For example, the program code for the adaptive reverse engineering application on agent computing nodes 116, when executed by the agent processors, can cause the agent processors of agent computing nodes 116 to map the processor trace data to decompiled code data (e.g., via Ghidra) from decompiled code database 110 to generate the source code file. In some embodiments, agent computing nodes 116 can generate a mapping that can be stored in decompiled code database 110.

In some embodiments, the program code for the malware detection application, when executed, can cause the processor to execute the source code file to identify the malware beacon in the source code file based on the malware beacon being embedded in the binary data stream. For example, malware detection application 104, when executed, can cause processor 106 to execute the source code file received from at least one agent computing node 116. Processor 106 can execute the source code file to identify the malware beacon, where execution of the source code file recreates and/or simulates a malware beacon that is includes code embedded in the binary data stream. In this way, reverse engineering the binary data stream can allow for malware detection node to simulate/emulate message transmission of the binary data, so that a malware beacon can be identified and intercepted.

In some embodiments, the program code for the malware detection application, when executed, can cause the processor to execute the source code file to store beacon identifier data for the beacon transmission and a cryptographic key associated with an encrypted data transmission in a malware database for detection of the malware beacon within the computer network. For example, malware detection application 104, when executed, can cause processor 106 to store beacon identifier data for the malware beacon transmission, where the beacon identifier can be extracted form the malware beacon transmission. The beacon identifier can include a network attribute, or other identifier uniquely identifying the malware beacon transmission. Processor 106 can also extract a cryptographic key associated with an encrypted data transmission (e.g., the malware beacon transmission) in a malware database. The cryptographic key can be used for simulating/emulating malware beacon transmission and/or for detection of a malware beacon within the computer network.

In some embodiments, the program code for the malware detection application, when executed, can cause the processor to generate decompiled program code based on the binary data stream. For example, malware detection application 104, when executed, can cause processor 106 to generate decompiled program code based on the binary data stream by using a decompiling tool (e.g., Ghidra) on the binary data stream. The binary data stream can include compiled program code (e.g., binary code).

In some embodiments, the program code for the malware detection application, when executed, can cause the processor to identify a first offset and a last offset for each of plural functions in the processor trace data. For example, malware detection application 104, when executed, can cause processor 106 to identify a first offset and a last offset for each of plural functions in the processor trace data, where functions can be mapped based on executing the processor trace with processor trace system 112.

In some embodiments, the program code for the malware detection application, when executed, can cause the processor to correlate the first offset and the last offset of each of the plural functions to the decompiled program code. For example, malware detection application 104, when executed, can cause processor 106 to correlate the first offset and the last offset of each of the plural functions to the decompiled program code. Processor 106 can correlate the offsets based on analysis of both the processor trace data and the decompiled code output.

Computing system 100 can include memory 108 including storage locations configured to store binary data and/or binary data files, and network attributes (e.g., malware identifiers, beacon identifiers, and/or the like). Computing system 100 can include decompiled code database 110 configured for storing binary data, binary data files, network attributes (e.g., malware identifiers, beacon identifiers) and/or other data related to the binary data stream and/or malware files. Computing system 100 can include processor 106 configured with malware detection application 104. Processor 106 can be specially configured to execute program code that, when executed, can cause processor 106 to execute program code for malware detection application 104. In some embodiments, processor 106 can be specially configured to execute program code that, when executed, can cause processor 106 to execute program code for processor trace system 112. Computing system 100 can include distributed agent computing nodes 116 that can be in communication with malware detection node 102 to transmit reverse engineering data and/or malware data back to malware detection node 102. Agent computing nodes 116 can also be in communication with controller node 114 that controls and manages execution of reverse engineering tasks by agent computing nodes 116. Agent computing nodes 116 can share data and reverse engineering breakthroughs with one another through controller node 114.

As used herein, “breakthrough” and/or “reverse engineering breakthrough” can refer to at least one agent computing node 116 achieving successful analysis of the binary data stream such that data obtained and/or generated by the at least one agent computing node 116 satisfies at least on conditional attribute. At least one agent computing node 116 can share a breakthrough with each other agent computing node 116 within the agent computing node network. For example, in some embodiments, where at least one agent computing node 116 successfully achieves a reverse engineering breakthrough, the at least one agent computing node may share the breakthrough with each other agent computing node 116 via a gossip protocol. In some embodiments, a gossip protocol can include a peer-to-peer (e.g., agent computing node 116-x to agent computing node 116-y) communication method that can spread data and/or generated scripts across a computing network by having agent computing nodes 116 exchange information with each other. The gossip protocol can be used among agent computing nodes 116 to ensure that all agent computing nodes 116 have access to the data obtained and/or generated by one agent computing node 116.

Execution of malware detection application 104 can configure processor 106 to perform various functions, as described herein. Additionally, execution of the program code for the adaptive reverse engineering application on each of plural agent computing nodes 116 can configure computing system 100 to perform various functions, as described herein. Further, execution of the program code for controller node 114 can configure computing system 100 to perform various functions, as described herein.

In some embodiments, malware detection application 104 can configure processor 106 to execute other functions. Similarly, the program code for the adaptive reverse engineering application on each of plural agent computing nodes 116 can configure computing system 100 to perform other functions and the program code for controller node 114 can configure computing system 100 to perform other functions.

Execution of malware detection application 104 can configure processor 106 to iteratively execute various functions. Similarly, the program code for the adaptive reverse engineering application on each of plural agent computing nodes 116 can configure agent computing nodes 116 to iteratively execute various functions. In some embodiments, malware detection application 104, the program code for the adaptive reverse engineering application on each of plural agent computing nodes 116, and/or processor trace system 112 can configure processor 106 and/or agent computing nodes 116 to execute any of the functions disclosed herein, and/or execute other various functions for reverse engineering binary data and/or detecting malware or other malicious code. Additionally, the program code for controller node 114 can configure controller node 114 to execute any of the functions disclosed herein, and/or execute other various functions for reverse engineering binary data and/or detecting malware or other malicious code.

As shown in FIG. 1, computing system 100 and/or malware detection node 102 can be implemented across plural computing nodes (e.g., plural, distributed agent computing nodes 116, controller node 114, etc.) within a computer network.

In some embodiments, malware detection node 102 can be implemented in a single computing device. Malware detection node 102 can be implemented in one or more computing devices (e.g., a group of servers, such as a group of computing devices, and/or the like) as a distributed and/or decentralized system such that software instructions, malware detection application 104 and/or processor trace system 112, are implemented on different computing devices. In some embodiments, malware detection node 102 can be associated with a local computing device, such that malware detection node 102 is executed on the local computing device or part of malware detection node 102 is executed on the local computing device as part of a distributed and/or decentralized computing system. Alternatively, malware detection node 102 can include at least one local computing device executing software instructions for detecting malware within a computer network.

Computing system 100 can be configured for reverse engineering binary data and/or detecting malware in a computer network. Computing system 100 can include memory (e.g., memory 108) storing program code for a reverse engineering application (e.g. the same as or similar to malware detection application 104). Computing system 100 can include a database (e.g., decompiled code database 110) storing conditional attributes defining successful decompiling of binary program code. Computing system 100 can also include plural agent nodes each including an agent processor and an agent memory storing program code for an agent reverse engineering application (e.g., agent computing nodes 116). Computing system 100 can include a controller node in communication with the plural agent nodes. Computing system 100 can also include a malware detection node (e.g., malware detection node 102) including a processor (e.g., processor 106) for decompiling binary program code configured to communicate with the memory storing program code for the reverse engineering application. In some embodiments, plural agent computing nodes 116 can be peer-to-peer computing nodes in communication with one another.

The program code for the reverse engineering application, when executed, can cause the processor to receive a binary file including binary program code. For example, the program code for malware detection application 104 can cause processor 106 to receive a binary file including binary program code. In some embodiments, the binary file including binary program code can include compiled program code for malware. The program code for the reverse engineering application, when executed, can cause the processor to receive text input data which defines a goal of reverse engineering the binary file. For example, the program code for malware detection application 104 can cause processor 106 to receive text input data which defines a goal of reverse engineering the binary file. The text input data may be provided by a user via an input device, or the text input may be provided via a file including text data representing prompts for malware detection application 104 and/or agent computing nodes 116. In this way, the text input data can represent instructions and/or prompts for reverse engineering the binary file, such that agent computing nodes 116 can receive the instructions for performing a task of reverse engineering the binary file.

In some embodiments, the program code for the reverse engineering application, when executed, can cause the processor to automatically decompose the text input data into one or more conditional attributes for validating a task associated with reverse engineering the binary file. For example, the program code for malware detection application 104 can cause processor 106 to automatically decompose the text input data into one or more conditional attributes for validating a task associated with reverse engineering the binary file. Processor 106 can automatically decompose the text input data using at least one large language model (LLM) to generate one or more tasks, each task being associated with a conditional attribute for reverse engineering the binary file. The tasks and/or conditional attributes may be provided to plural agent computing nodes 116 for performing tasks to reverse engineer the binary file. Agent computing nodes 116 can also use the conditional attribute to validate whether a task is complete or not complete, depending on whether agent computing nodes 116 generated a report and/or output that satisfies the conditional attribute.

In some embodiments, the program code for the reverse engineering application, when executed, can cause the processor to transmit the binary file and the one or more conditional attributes to each agent node. For example, the program code for malware detection application 104 can cause processor 106 to transmit the binary file and the one or more conditional attributes to each agent computing node 116 so that each agent computing node 116 can analyze the binary file independently, while any breakthrough achieved by at least one agent computing node 116 can be shared among each agent computing node 116 to synchronize agent computing nodes 116 so that reverse engineering of the binary file can progress more efficiently while conserving computing resources.

In some embodiments, the program code for the reverse engineering application, when executed, can cause the processor to receive and execute a final validated source code file to intercept a malware beacon transmission within the computing system. For example, the program code for malware detection application 104 can cause processor 106 to receive and execute a final validated source code file to intercept a malware beacon transmission within the computing system. Processor 106 can receive and execute the final validated source code file after agent computing nodes 116 have completed reverse engineering tasks and have satisfied and/or validated all conditional attributes to generate the final validated source code file. Once the final validation source code file is generated by agent computing nodes 116, agent computing nodes 116 can transmit the final validated source code to malware detection node 102 (and processor 106).

The program code for the agent reverse engineering application on each agent node, when executed, can cause each agent processor to iteratively generate a processor trace output by executing the binary file while tracing instructions of the processor. For example, the program code for the agent reverse engineering application on each agent computing node 116, when executed, can cause each agent processor on each agent computing node 116 to iteratively generate a processor trace output by executing the binary file while tracing instructions of each agent processor using processor trace system 112. In some embodiments, tracing the instructions of the agent processor can include calling an API for executing a processor trace. Agent computing nodes 116 can request a processor trace from processor trace system 112 using API calls to processor trace system 112.

The program code for the agent reverse engineering application on each agent node, when executed, can cause each agent processor to iteratively map the processor trace output to decompiled code output to generate a source code file based on the binary file. For example, the program code for the agent reverse engineering application on each agent computing node 116, when executed, can cause each agent processor on each agent computing node 116 to iteratively map the processor trace output to decompiled code output to generate a source code file based on the binary file. In some embodiments, the decompiled code output can be stored in decompiled code database 110. As each agent computing node 116 maps processor race output to decompiled code, each agent computing node 116 can generate a different source code file. Where at least one agent computing node 116 generates a source code file that satisfies at least one conditional attribute (e.g., a conditional attribute associated with a task and/or subtask), the at least one agent computing node 116 can be said to experience a breakthrough in reverse engineering the binary file. The at least one agent computing node 116 can share the breakthrough with other agent computing nodes 116, such that the source code files generated by the other agent computing nodes 116 are updated to match the source code file generated by the at least one agent computing node 116 that resulted in the breakthrough. Then, plural agent computing nodes 116 can begin a new iteration of mapping new processor trace output to new decompiled code to generate new source code files until another one of plural agent computing nodes 116 experiences a subsequent breakthrough. In some embodiments, iterations may continue until all existing conditional attributes are satisfied and/or the binary file has been reverse engineered.

The program code for the agent reverse engineering application on each agent node, when executed, can cause each agent processor to iteratively determine a validated source code file such that the source code file satisfies at least one conditional attribute of the one or more conditional attributes. For example, the program code for the agent reverse engineering application on each agent computing node 116, when executed, can cause each agent processor on each agent computing node 116 to iteratively determine a validated source code file such that the source code file satisfies at least one conditional attribute of the one or more conditional attributes. In some embodiments, when at least one agent computing node 116 determines a validated source code file such that the source code file satisfies at least one conditional attribute of the one or more conditional attributes, the validated source code file can be referred to as a breakthrough and/or at least one agent computing node 116 can be referred to as experiencing a breakthrough because the reverse engineering tasks of the at least one agent computing node 116 produced results that satisfied at least one conditional attribute. In some embodiments, at least one agent computing node 116 can generate a report including validated results (e.g., which may or may not include a validated source code file) that satisfy at least one conditional attribute as part of the breakthrough. The at least one agent computing node 116 can share the breakthrough and/or the report including the validated results with each other agent computing node 116 such that each other agent computing node 116 can apply the validated results to the next iteration to make further progress on reverse engineering the binary file. In this way, plural agent computing node s116 can synchronize with each other (e.g., at each iteration) to arrive at a solution to reverse engineering the binary file faster with reduced computing resources.

The program code for the controller node, when executed, can cause the controller node to transmit the validated source code file to each of the agent nodes to update the source code file to a validated source code file on each agent node. For example, the program code for controller node 114, when executed, can cause controller node 114 to receive the validated source code file from at least one agent computing node 116 and subsequently transmit a copy of the validated source code file to each of agent computing nodes 116 to update the source code file to a validated source code file on each agent computing node 116 to synchronize agent computing nodes 116 for the next iteration.

The program code for the controller node, when executed, can cause the controller node to terminate iterative execution of each agent reverse engineering application to generate the final validated source code file based on determining that all of the one or more conditional attributes are satisfied. For example, the program code for controller node 114, when executed, can cause controller node 114 to terminate iterative execution of each agent reverse engineering application on each agent computing node 116 to generate the final validated source code file based on determining that all of the one or more conditional attributes are satisfied. At least one agent computing node 116 can generate the final validated source code file and can share the final validated source code file with malware detection node 102 and/or each other agent computing node 116. Once a final validated source code file (e.g., or final results) is generated, iterative execution of agent computing nodes 116 can be terminated because all conditional attributes will have been determined to be satisfied and no more reverse engineering tasks need to be performed via agent computing nodes 116.

The program code for the controller node, when executed, can cause the controller node to cause an agent node to transmit the final validated source code file to the malware detection node for intercepting a malware beacon transmission. For example, the program code for controller node 114, when executed, can cause controller node 114 to transmit the final validated source code file to malware detection node 102 for intercepting a malware beacon transmission. Malware detection node 102 can receive the final validated source code file, which may simulate/emulate malware and/or a component of malware that can transmit and/or receive a malware beacon transmission. Malware detection node 102 can execute the final validated source code to transmit a malware beacon such that malware detection node 102 can identify the malware beacon and store information and/or data associated with the malware beacon for subsequent detection within the computing network. In some embodiments, the source code file (or the validated source code file) can include program code for a command and control server.

In some embodiments, the program code for the reverse engineering application, when executed, can cause the processor to store the final validated source code file in the database for use in intercepting malware transmissions and/or detecting malware. For example, the program code for the reverse engineering application, when executed, can cause processor 106 to store the final validated source code file in decompiled code database 110 for subsequent use in intercepting malware transmissions and/or detecting malware in real time.

When the program code for the agent reverse engineering application causes at least one agent processor to transmit the validated source code file to each of the agent nodes to update the source code file to a validated source code file on each agent node, the program code for the agent reverse engineering application can cause the processor to synchronize the conditional attribute and the validated source code file on each agent node. For example, when the program code for the agent reverse engineering application causes at least one agent processor on agent computing nodes 116 to transmit the validated source code file to each of agent computing nodes 116 to update the source code file to a validated source code file on each agent computing node 116, the program code for the agent reverse engineering application can cause the agent processor to synchronize the conditional attribute and the validated source code file on each agent computing node 116. Agent computing nodes 116 can synchronize the conditional attribute and the validated source code file on the group of agent computing nodes 116 such that each agent computing node 116 has the same validated source code file to use as an input for subsequent iterations of code analysis, and each agent computing node 116 has access to data indicating that a number of conditional attributes have been satisfied.

When the program code for the agent reverse engineering application causes at least one agent processor to transmit the validated source code file to each of the agent nodes to update the source code file to a validated source code file on each agent node, the program code for the agent reverse engineering application can cause the processor to begin a new iteration to generate the processor trace output by executing the binary file while tracing instructions of the agent processor. For example, when the program code for the agent reverse engineering application causes at least one agent processor of agent computing nodes 116 to transmit the validated source code file to each of agent computing nodes 116 to update the source code file to a validated source code file on each agent computing node 116, the program code for the agent reverse engineering application can cause the agent processor to begin a new iteration (e.g., a subsequent iteration) to generate new processor trace output by executing the binary file while tracing instructions of the agent processor on each agent computing node 116 based on additional conditional attributes existing (e.g., stored in decompiled code database 110) that have not been satisfied by the validated source code file.

When the program code for the agent reverse engineering application on each agent node causes each agent processor to iteratively map the processor trace output to the decompiled code output to generate the source code file, the program code for the agent reverse engineering application on each agent node will cause the agent processor to identify a first offset and a last offset for each of plural functions in the processor trace output. For example, when the program code for the agent reverse engineering application on each agent computing node 116 causes each agent processor to iteratively map the processor trace output to the decompiled code output to generate the source code file, the program code for the agent reverse engineering application on each agent computing node 116 will cause the agent processor to identify a first offset and a last offset for each of plural functions in the processor trace output. The processor trace output can improve and/or change at each iteration of each agent computing node 116 and each agent computing node 116 can share the processor trace output with other agent computing nodes 116.

When the program code for the agent reverse engineering application on each agent node causes each agent processor to iteratively map the processor trace output to the decompiled code output to generate the source code file, the program code for the agent reverse engineering application on each agent node can cause the agent processor to correlate each function to the decompiled code output using the first offset and the last offset for each function. For example, when the program code for the agent reverse engineering application on each agent computing node 116 causes each agent processor to iteratively map the processor trace output to the decompiled code output to generate the source code file, the program code for the agent reverse engineering application on each agent computing node 116 can cause the agent processor to correlate each function to the decompiled code output using the first offset and the last offset for each function. In this way, each agent computing node 116 can analyze the processor trace output by comparing and correlating the processor trace output with the decompiled code to determine how a reverse engineered source code file could be structured, based on the processor trace output and decompiled code correlation. This analysis can assist each agent computing node 116 in reconstructing and reverse engineering source code representing the binary file and/or a component associated with the binary file.

The program code for the reverse engineering application, when executed, can cause the processor to receive text input data which defines a goal of reverse engineering the binary file. For example, processor 106 can receive text input data defining a goal of reverse engineering the binary file from a user and/or a client device. The text input data can be sent to at least one large language model (LLM) for processing and or decomposition of the text input data. The text input data can define a high-level goal of reverse engineering the binary file. For example, the text input data can include text data such as “analyze a malware sample to create a command and control server.” This text input can be input to a LLM, and the LLM can tokenize and/or analyze the text input data to output a series of milestones and/or tasks that should be completed by malware detection system 102 in order to create a command and control server (e.g., command and control device 114) that corresponds to and/or is associated with the binary data file. The command and control server, generated by malware detection node 102, can be in the form of a script or program code for operating and/or simulating/emulating the command and control server. Another example of a goal can include “identify whether the binary data is malicious” or “identify an output of the binary data.” It should be understood that many different goals can be input as text input data and computing system 100 can formulate and perform tasks for many different goals.

The program code for the reverse engineering application, when executed, can cause the processor to automatically decompose the text input data into one or more conditional attributes for validating a task associated with reverse engineering the binary file. For example, processor 106 can automatically decompose the text input data into one or more conditional attributes using the LLM. The conditional attributes can be stored in malware and decompiled code database 110 and/or memory 108 for validating a task performed by processor 106 associated with reverse engineering the binary file. For example, a conditional attribute for validating a task can include whether a processor trace of the binary file was successfully performed, where the task required the processor trace of the binary file to be performed. Once processor 106 and/or processor trace system 112 performs a processor trace on the binary file and generates processor trace data, processor 106 can validate the conditional attribute and can set the conditional attribute to “TRUE” when the conditional attribute is satisfied. In this way, malware detection node 102 and processor 106 can automatically track progress of reverse engineering the binary file so that the reverse engineering process can be continually analyzed and improved.

In some embodiments, when the program code for the reverse engineering application causes the processor to automatically decompose the text input data, the program code for the reverse engineering application can cause the processor to input the text input data to at least one LLM. For example, processor 106 can automatically decompose the text input data using the text input data as input to the LLM for contextual analysis of the text. In some embodiments, an LLM can be trained based on the text input data (or multiple sets of text input data).

In some embodiments, when the program code for the reverse engineering application causes the processor to automatically decompose the text input data, the program code for the reverse engineering application can cause the processor to generate, with the LLM, one or more milestones associated with the goal of reverse engineering the binary file defined by the text input data, where each milestone is defined by text data and at least one subtask. For example, processor 106 can generate and output (using the LLM) plural milestones in a text data format such that the plural milestones can include prompts that can be input into the LLM to further generate tasks and/or subtasks to progress in the goal for reverse engineering the binary data.

In some embodiments, when the program code for the reverse engineering application causes the processor to automatically decompose the text input data, the program code for the reverse engineering application can cause the processor to generate, with the LLM, the one or more conditional attributes based on providing the one or more milestones as input to the LLM. The one or more conditional attributes can be Boolean expressions for validating a task associated with a milestone. As an example, processor 106 can generate, with the LLM, the one or more conditional attributes based on providing the one or more milestones as input to the LLM. Processor 106 can generate text format subtasks that are associated with the conditional attributes.

In some embodiments, when the program code for the agent reverse engineering application on each agent node causes the agent processor to determine that the source code file satisfies the at least one conditional attribute, the program code for the agent reverse engineering application can cause the agent processor to execute the source code file for test execution to validate the at least one conditional attribute. Executing the source code file can cause at least one output that satisfies the at least one conditional attribute. For example, each agent computing node 116 can execute the source code file for test execution to validate the at least one conditional attribute and agent computing nodes 116 can share breakthroughs with other agent computing nodes 116 where appropriate. At least one agent computing nodes 116 can determine that at least one output or at least one attribute (e.g., a network attribute) of the source code file satisfies the at least one conditional attribute.

In some embodiments, when the program code for the agent reverse engineering application causes the agent processor of each agent computing node 116 to determine that the source code file satisfies the at least one conditional attribute, the program code for the agent reverse engineering application can cause the agent processor to transmit the source code file to malware detection node 102 for storage in a decompiled code database for malware analysis based on satisfying the at least one conditional attribute. For example, processor 106 can receive the source code file from at least one agent computing node 116 and store the source code file in a database for later malware analysis and/or transmission interception. In this way, malware detection node 102 can receive a rapidly analyzed and/or generated source code file from agent computing nodes 116 and can store the source code file for later execution for analyzing and/or simulating/emulating malware code or for detecting transmission of malware beacons. The source code file can represent a malware file directly or the source code file can represent a component associated with a malware file (e.g., a command and control server) such that execution of the source code file provides simulation/emulation of aspects of the malware code so the malware code can be studied and detected if the malware code is used maliciously.

In some embodiments, the source code file can include a script that, when executed by the processor or the agent processors, causes the processor or the agent processors to simulate or emulate a communication message transmitted by program code for malware. For example, processor 106 can execute the source code file (e.g., a script) such that processor 106 can execute commands associated with a command and control server. In some embodiments, a processor executing the source code file can act as a command and control server that is related to the binary data (e.g., the malicious program code) such that malware detection node 102 can analyze data and network traffic of the command and control server to collect malware data and/or network attributes related to the binary data. The malware data and/or network attributes can be stored in decompiled code database 110 for subsequent detection of live malware attacks and live messages from malware code to command and control servers within a computing network. In this way, malware detection node 102 can efficiently collect malware data and/or network attributes by automating reverse engineering tasks to reverse engineer the binary data and analyze a malware sample before similar malware can infect the computing network.

The program code for the reverse engineering application, when executed, can cause the processor to detect at least one malware beacon based on the source code file. For example, processor 106 can detect at least one malware beacon transmitted to/from a command and control server (e.g., whether simulated/emulated by a source code file available in decompiled code database 110 or transmitted by an operating malicious command and control server) based on the analysis of the binary file. Processor 106 can use malware data, such as network attributes associated with a malware file (e.g., the binary file) stored in decompiled code database 110, to analyze and identify a beacon transmission, or identify network attributes of a malware beacon transmission. In some embodiments, processor 106 can identify network attributes by executing the source code file (e.g., a decompiled version of the binary file, stored in decompiled code database 110) to determine the network attributes from execution of a decompiled version of the malware file. Additionally or alternatively, processor 106 can identify the network attributes by analyzing the decompiled code of the source code file to determine the network attributes stored and/or present in the decompiled code of the source code file. Based on the identified network attributes, processor 106 can detect the malware beacon when the malware beacon is transmitted by intercepting a data transmission and determining that the data transmission includes at least one of the identified network attributes.

Computing system 100 can include one or more computing devices (e.g., malware detection node 102, controller node 114, agent computing nodes 116) each including one or more processors (e.g., processor 106, agent processors, controller processors, etc.) configured to execute software instructions. For example, malware detection node 102 can include a desktop computer, a portable computer (e.g., laptop computer, tablet computer), a workstation, a mobile device (e.g., smartphone, cellular phone, personal digital assistant, wearable device), a server, and/or other like devices. Malware detection node 102 can include a computing device configured to communicate with one or more other computing devices (e.g., agent computing nodes 116) over a network. Malware detection node 102 can include a group of computing devices (e.g., a group of servers) and/or other like devices. In some embodiments, malware detection node 102 can include a data storage device (e.g., decompiled code database 110) for storing conditional attributes, malware code and/or malware data, and decompiled code. Alternatively, a data storage device can be separate from malware detection node 102 and can be in communication with malware detection node 102 over a network.

Processor 106 can be implemented in hardware, software, or a combination of hardware and software. For example, processor 106 can include a common processor (e.g., a CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed and/or can execute software instructions to perform a function. Processor 106 can be coupled to memory 108 via a data bus to transfer data between processor 106 and memory 108. Agent processors and/or controller processors can be the same as or similar to processor 106.

Memory 108 can include random access memory (RAM), read-only memory (ROM), and/or another type of dynamic or static storage device (e.g., flash memory, magnetic memory, optical memory, etc.) that stores information and/or software instructions for use by processor 106. Memory 108 can include a computer-readable medium and/or a storage component. A computer-readable medium (e.g., a non-transitory computer-readable medium) is defined herein as a non-transitory memory device. A non-transitory memory device includes memory space located inside of a single physical storage device or memory space spread across multiple physical storage devices. In some embodiments, memory 108 can include one or more storage locations for storing data, binary data, malware data, and/or data associated with conditional attributes. Agent memories and/or controller memories can be the same as or similar to memory 108.

Software instructions can be read into memory 108 from another computer-readable medium or from another device via a communication interface with malware detection node 102. When executed, software instructions stored in memory 108 can cause processor 106 to perform one or more processes and/or functions described herein. Additionally, software instructions can be read into agent memories for execution by agent processors in agent computing nodes 116, and software instructions can be read into controller memory and executed by a controller processor on controller node 114. Embodiments described herein are not limited to any specific combination of hardware circuitry and software and can include various combinations of hardware circuitry and software.

Decompiled code database 110 can include random access memory (RAM), read only memory (ROM), and/or another type of dynamic or static storage device (e.g., flash memory, magnetic memory, optical memory, etc.) that stores information for use by malware detection system 102 and/or processor 106. For example, decompiled code database 110 can store one or more malware samples and/or data associated with one or more malware samples (e.g., network attributes, conditional attributes, decompiled code, source code files, scripts, etc.). Decompiled code database 110 can store machine learning models and/or LLMs for use by malware detection node 102, processor 106, and/or agent computing nodes 116. In some embodiments, decompiled code database 110 can store decompiled code, or binary data decompiled into source code and/or pseudo source code. In some embodiments, decompiled code database 110 can include a non-transitory computer readable medium that can store information, software, and/or machine learning models related to the operation and use of malware detection node 102 and/or processor 106. For example, decompiled code database 110 can include a hard disk (e.g., a magnetic disk, an optical disk, a magneto-optic disk, a solid-state disk, etc.) and/or another type of computer-readable medium. In some embodiments, malware detection node 102, processor 106, and/or agent computing nodes 116 can transmit information to and/or receive information from decompiled code database 110.

Decompiled code database 110 can include a computing device (e.g., a database device) configured to communicate with processor 106 (e.g., via malware detection application 104) via a bus or a network environment. For example, decompiled code database 110 can include a server, a group of servers, and/or other like devices. In some embodiments, decompiled code database 110 can be associated with one or more computing devices providing interfaces such that a user can interact with decompiled code database 110 via the one or more computing devices. Decompiled code database 110 can be in communication with malware detection node 102 and/or processor 106 such that decompiled code database 110 is separate from malware detection node 102 and/or processor 106. Alternatively, decompiled code database 110 can be part of (e.g., a component of) malware detection node 102.

In some embodiments, decompiled code database 110 can include a device capable of storing data (e.g., a database). In some embodiments, decompiled code database 110 can include a collection of data (e.g., malware data elements, decompiled code, network attributes, etc.) stored and accessed by one or more computing devices. Decompiled code database 110 can include file system storage, cloud storage, in-memory storage, and/or the like. Decompiled code database 110 can include non-volatile storage (e.g., flash memory, magnetic media), volatile storage (e.g., random access memory (RAM)), or both non-volatile and volatile storage. In some embodiments, decompiled code database 110 can be hosted (e.g., stored and permitted to be accessed by other computing devices via a network environment) on a computing device separate from malware detection node 102. Decompiled code database 110 can be configured to communicate with processor 106 via malware detection application 104.

As used herein, an application (e.g., software application, software/hardware module, and/or the like) or a service (e.g., software service, microservice, and/or the like) can refer to a loosely-coupled software application and/or a loosely-coupled software service that is designed to facilitate software reuse and high cohesion. In a microservice architecture, software services can be fine-grained and protocols can generally be lightweight, requiring minimal software dependencies. Software applications and/or services can include interfaces which are treated as a public API. The software application and/or software service can exist and may be reusable (e.g., portable to other software applications and/or systems without requiring changes to the software application) independent of other software applications and/or software services.

Malware detection application 104 can include a component (e.g., programmed hardware component, software component) for interfacing processor 106 with at least memory 108, decompiled code database 110, processor trace system 112, and/or agent computing nodes 116. For example, malware detection application 104 can allow processor 106 to interface with memory 108 such that processor 106 can store and/or retrieve objects and/or data in memory 108 (e.g., binary data, binary files, network attributes, conditional attributes, and/or the like). Malware detection application 104 can include program code that causes processor 106 to execute API calls to processor trace system 112 to perform a processor trace on another file (e.g., a source code file, a script) being executed. Malware detection application 104 can include program code that causes processor 106 to communicate with agent computing nodes 116 to transmit and receive data (e.g., binary data, source code files, etc.). In some embodiments, malware detection application 104 can include a software application (e.g., an application invoked by processor 106 based on program code executed by processor 106) such that functionalities of malware detection application 104 can be accessed via an API. In some embodiments, malware detection application 104 can include a software application such that malware detection application 104 can be packaged into a single unit (e.g., a single unit of reusable program code) that can be easily deployed and/or shared between computing devices and/or multiple computing systems 100. In some embodiments, malware detection application 104 can include a combination of hardware and software (e.g., a specially configured processor, an embedded system, a separate computing node) such that malware detection application 104 can perform functions and share data and/or commands with processor 106, where malware detection application 104 is executed on hardware separate from processor 106. Alternatively, malware detection application 104 can include a software application and/or service including various program instructions that can be executed by processor 106. The program instructions for malware detection application 104 can cause processor 106 to interface with memory 108 to manipulate objects and/or data (e.g., binary data, binary files, network attributes, conditional attributes, and/or the like). For example, malware detection application 104 can include various functions in program code that can cause processor 106 to performs functions described herein.

As disclosed herein, an application can include software, hardware, or a combination of software and hardware. As an example, where malware detection application 104 can include program code that, when executed by processor 106, will cause processor 106 to perform various actions, malware detection application 104 can include program code including various functions that cause processor 106 to be configured to perform the various functions when processor 106 executes malware detection application 104. Alternatively, where malware detection application 104 includes program code and/or computer instructions (e.g., via hardware or software) in a combination of software and hardware, malware detection application 104 can include a package of program code and hardware (e.g., a specially configured processor, an embedded system, a separate computing node) to perform various functions independent of and/or in conjunction with processor 106. In this way, malware detection application 104 can include various functions (e.g., via hardware or software) where malware detection application 104 can be configured with its own hardware and/or processor for performing the various functions and malware detection application 104 can be integrated with processor 106 to form a packaged malware detection system 102 including a specially programmed and/or configured processor.

Processor trace system 112 can include a component (e.g., programmed hardware component, software component) for interfacing processor 106, malware detection application 104, and/or agent computing nodes 116 with a processor trace application. For example, processor trace system 112 can allow processor 106 to interface with a processor trace application such that processor 106 can execute a processor trace of another application, file, script, and/or program code. In some embodiments, processor trace system 112 can include a software application (e.g., an application invoked by processor 106 based on program code executed by processor 106) such that functionalities of processor trace system 112 can be accessed via an API. In some embodiments, processor trace system 112 can include a software application such that processor trace system 112 can be packaged into a single unit (e.g., a single unit of reusable program code) that may be easily deployed and/or shared between computing devices and/or multiple computing systems 100. In some embodiments, processor trace system 112 can include a combination of hardware and software (e.g., a specially configured processor to perform certain functions) such that processor trace system 112 is separate from processor 106 and/or agent processors of agent computing node 116 and can perform functions and share data and/or commands with processor 106 and/or agent processors of agent computing node 116. Processor trace system 112 can include various functions (e.g., via hardware or software) that can allow processor 106 and/or agent processors to call processor trace system 112 to execute a processor trace on a software application, a binary file, a script file, and/or other compiled and/or executable program code to generate processor trace data. For example, processor trace system 112 can include various functions in program code that can cause processor 106 to performs functions described herein and/or that can allow processor 106 to invoke processor trace system 112 (e.g., via an API) to execute a processor trace.

As disclosed herein, an application can include software, hardware, or a combination of software and hardware. As an example, where processor trace system 112 includes program code that, when executed by processor 106 and/or agent processors, can cause processor 106 and/or agent processors to perform various actions, processor trace system 112 can include program code including various functions that cause processor 106 and/or agent processors to be configured to perform the various functions when processor 106 and/or agent processors executes processor trace system 112 and/or executes API calls to processor trace system 112. Alternatively, where processor trace system 112 includes various functions (e.g., via hardware or software) in a combination of software and hardware, processor trace system 112 can include a package of program code and hardware (e.g., a specially configured processor, an embedded system, a separate computing node) to perform the various functions independent of and/or in conjunction with processor 106 and/or agent processors, where processor trace system 112 includes hardware and/or software separate from processor 106 and/or agent processors. In this way, processor trace system 112 can include program code where processor trace system 112 can be configured with its own hardware and/or processor for performing various functions and processor trace system 112 can be integrated with malware detection node 102 to form a packaged processor trace system 112 including a specially programmed and/or configured processor.

As shown in FIG. 1, malware detection node 102 (e.g., processor 106 thereof) can perform various functions based on processor 106 being configured to execute program code that, when executed, can cause processor 106 to execute malware detection application 104 (e.g., program code for malware detection application 104) and processor trace system 112 (e.g., program code for processor trace system 112). In some embodiments, processor 106 can execute malware detection application 104 and/or processor trace system 112 as program code. Alternatively, processor 106 can execute malware detection application 104 and/or processor trace system 112 by communicating with a first specially configured processor and/or computing device corresponding to malware detection application 104 and/or communicating with a second specially configured processor and/or computing device corresponding to processor trace system 112, for example, via an API or via a remote procedure call (RPC), where malware detection application 104 and/or processor trace system 112 can be configured with first program code and second program code, respectively. It should be understood that agent processors on agent computing nodes may operate the same as or similar to processor 106.

The number and arrangement of systems, hardware, and/or applications shown in FIG. 1 is provided as an example. There may be additional systems, hardware, and/or applications, fewer systems, hardware, and/or applications, different systems, hardware, and/or applications, or differently arranged systems, hardware, and/or applications than those shown in FIG. 1. Furthermore, two or more systems, hardware, and/or applications shown in FIG. 1 can be implemented within a single system, hardware, and/or application. A single system, hardware, and/or application shown in FIG. 1 can be implemented as multiple, distributed systems, hardware, and/or applications. Additionally, or alternatively, a set of systems, a set of hardware, and/or a set of applications (e.g., one or more systems, one or more hardware devices, one or more modules) of FIG. 1 can perform one or more functions described as being performed by another set of systems, another set of hardware, or another set of applications of FIG. 1.

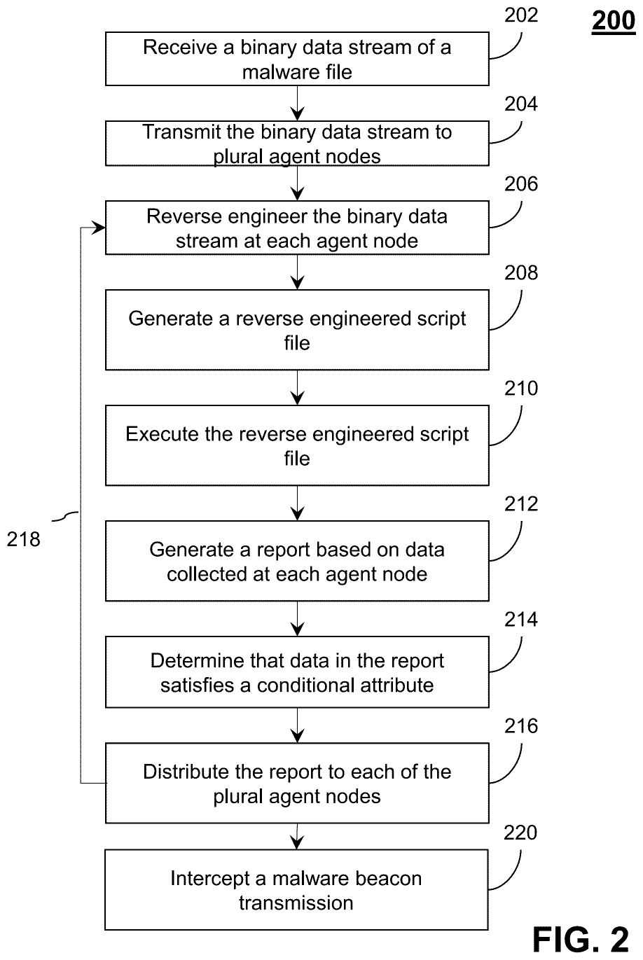

FIG. 2 shows a flow diagram of an exemplary method 200 for detecting malware in a computer network and/or reverse engineering binary data using a distributed network as disclosed herein. In some embodiments, one or more of the functions described with respect to method 200 can be performed (e.g., completely, partially, etc.) by malware detection node 102 (e.g., via processor 106), controller node 114, and/or agent computing nodes 116. In some embodiments, one or more of the steps of method 200 can be performed (e.g., completely, partially, etc.) by another system, hardware, or application or a group of systems, hardware, or applications separate from or including malware detection node 102, such as a client device and/or a separate computing device.

As shown in FIG. 2, at step 202, method 200 can include receiving a binary data stream of a malware file. For example, malware detection node 102 (e.g., processor 106 thereof) can receive a binary data stream of binary data representing a malware file. In some embodiments, controller 114 (e.g., including a controller processor) can receive a binary data stream of binary data representing a malware file. Controller 114 can receive the binary data stream via a user input or via malware detection node 102 where malware detection node 102 can receive the binary data stream via a user input from an input device and transmit the binary data stream to at least one agent computing node 116. The binary data stream can be compiled code for a malware file or a file representing malicious code. Processor 106 can receive the binary data stream as streaming data or processor 106 can receive the binary data stream in a file including binary data. Processor 106 can receive the binary data stream as a static sample of executable malicious code.

In some embodiments, malware detection node 102 can generate the conditional attribute representing validation criteria for a task to be satisfied. For example, malware detection application 104 can cause processor 106 to generate the conditional attribute representing validation criteria for a reverse engineering task to be satisfied by agent computing nodes 116. The conditional attribute can generated based on text input data provided to a LLM for analysis and/or decomposition into milestones and tasks.

At step 204, method 200 can include transmitting the binary data stream to plural agent nodes. For example, malware detection system 102 and/or controller 114 can transmit the binary data stream to plural agent computing nodes 116 in communication with controller node 114. Agent computing nodes 116 can receive the binary data stream for distributed code analysis, each agent computing node 116 performing independent code on analysis on the binary data stream while at least one agent computing node 116 can share any breakthroughs via a gossip protocol with each other agent computing node 116.

At step 206, method 200 can include reverse engineering the binary data stream at each agent node. For example, each agent computing node 116 can automatically reverse engineering the binary data stream to collect data about the binary data stream among the plural agent nodes. Agent processors of agent computing nodes 116 can reverse engineer the binary data stream to collect and/or extract a network attribute. Agent computing nodes 116 can extract the network attribute and can store the network attribute in decompiled code database 110 for later use and/or later identification of malware or transmission of a malware beacon. In some embodiments, the network attribute may be useful for identifying transmission of a malware beacon because the network attribute may match an attribute of the transmission of the malware beacon (e.g., a source/destination IP address, a cryptographic key used to encrypt the transmission of the malware beacon, a port number used to transmit the malware beacon, a transport protocol used for transmission of the malware beacon, or other attribute). Additionally, the network attribute can provide information or insight into an aspect of the malware file, such that communications by the malware file or execution of the malware file can be identified. Reverse engineering the binary data may be required to determine the network attribute, and the network attribute can be a key component in identifying and/or emulating malicious code such that the malicious code can be identified when it is executed for a malicious purpose.

In some embodiments, reverse engineering the binary data stream can include identifying and/or extracting a network attribute from the binary data stream. For example, each agent computing node 116, when reverse engineering the binary data stream, can identify a network attribute within the binary data stream and/or associated with the binary data. In some embodiments, identifying a network attribute may require first generating at least one conditional attribute representing validation criteria for a task to be satisfied. The at least one conditional attribute can be validated at each agent computing node 116 by each agent computing node 116 executing the script which includes the network attribute (e.g., a command or message transmitted using the network attribute, etc.). For example, agent computing nodes 116, when identifying the network attribute, can generate at least one conditional attribute representing validation criteria for a task to be satisfied.

In some embodiments, identifying the network attribute and extracting the network attribute can include executing the binary data representing the malware file to trace processor instructions. For example, each agent computing node 116 can execute the binary data representing the malware file to trace processor instructions while making API calls to processor trace system 112 to trace the processor instructions.

In some embodiments, identifying the network attribute and extracting the network attribute can include generating a processor trace output based on executing the binary data. For example, each agent computing node 116 can generate a processor trace output based on executing the binary data and executing a processor trace by calling processor trace system 112.

In some embodiments, identifying the network attribute and extracting the network attribute can include generating decompiled program code based on the binary data using a decompiling application. For example, each agent computing node 116 can generate decompiled program code based on the binary data using a reverse engineering code decompilation tool (e.g., Ghidra). Agent computing nodes 116 can transmit the decompiled program code to decompiled code database 110 for further analysis and/or agent computing nodes 116 can share the decompiled program code with other agent computing nodes 116.

In some embodiments, identifying the network attribute and extracting the network attribute can include integrating the processor trace output with the decompiled program code to generate the script for identifying and intercepting the beacon. For example, each agent computing node 116 can integrate the processor trace output with the decompiled program code (e.g., separately on each agent computing node 116 with processor trace output and decompiled program code specific to that agent computing node 116) to generate a script that can be used for identifying and intercepting the beacon transmission. By integrating the processor trace output with the decompiled program code, a more comprehensive view of the binary data and/or binary file in a decompiled source code version can be formed at each agent computing node 116. In some embodiments, the decompiled and/or integrated source code formed at each agent computing node 116 may be different such that each agent computing node 116 generates different results to differently evaluate the binary data stream and generate different scripts. In this way, each agent computing node 116 may differently validate or not validate the at least one conditional attribute.

Binary data and/or a binary file in a decompiled source code form can allow for more effective analysis by agent computing nodes 116 and/or malware detection node 102. Malware detection node 102 and/or agent computing nodes 116 can compare conditional attributes to portions of the decompiled source code form because the decompiled source code form can be similar to a human-readable version of the binary data (e.g., similar to source code). Tools such as LLMs can be leveraged to further analyze the decompiled source code form to improve analysis and reverse engineering of the binary data to create tools and scripts for identifying properties of the original binary data (such as malware beacons, or other attributes of malicious code). Thus, when each agent computing node 116 integrates the processor trace output with the decompiled program code, each agent computing node 116 can independently analyze a version of the integrated decompiled program code and processor trace output to generate a script that can simulate/emulate the original binary file. Each agent computing node 116 can then independently test the script that the respective agent computing node 116 had generated in a testing environment (e.g., in a virtual machine, a sandbox environment, and/or the like) to analyze malicious binary data (where the binary data represented a malware file, or other malicious file). Through testing the script, each agent computing node 116 may be able to identify more data and/or network attributes associated with the binary data that can be used for identifying and intercepting a transmission from malicious program code similar to the originally analyzed binary data (e.g., such as a beacon transmission to a command and control server for malware).

At step 208, method 200 can include generating a reverse engineered script file. For example, at least one agent computing node 116 can generate a reverse engineered script file based on code analysis performed on the binary data stream. The at least one agent computing node 116 can transmit the generated reverse engineered script file to malware detection node 102 for analysis and/or execution of the reverse engineered script file.

At step 210, method 200 can include executing the reverse engineered script file. For example, malware detection node 102 can execute the reverse engineered script file to extract data associated with the binary data stream. Malware detection node 102 can extract various data from the executed script file, including network attributes used in transmitting messages (e.g., IP addresses, cryptographic keys, transmission signatures, and/or the like). Malware detection node 102 can collect and store data from the executed script file for later identifying, detecting, and/or intercepting malware transmissions. Malware detection node 102 can intercept transmission of a malware beacon based on executing the reverse engineered script file. Processor 106 can execute the reverse engineered script and/or program code generated based on reverse engineering the binary data stream, where executing the script provides emulation of malware and/or provides insight into the malware data such that the malware data within the beacon transmission can be identified by processor 106. Additionally, processor 106 can intercept the beacon transmission and malware data because processor 106 may be able to access a network attribute stored in decompiled code database 110 and processor 106 can compare the network attribute to an attribute of the beacon transmission and/or the malware data. Processor 106 can positively identify and intercept the beacon transmission where at least one network attribute stored in decompiled code database 110 matches a network attribute of the beacon transmission.

In some embodiments, agent computing nodes 116 can extract a network attribute from the binary data stream while reverse engineering the binary data stream. In some embodiments, extracting the network attribute can include executing a script for test execution to validate the at least one conditional attribute. The script can satisfy the at least one conditional attribute upon execution. For example, a property and/or a function of the script can satisfy the at least one conditional attribute, or an output of the script can satisfy the at least one conditional attribute. In some embodiments, extracting the network attribute can include storing the script in a database (e.g., decompiled code database 110) for malware detection based on satisfying the at least one conditional attribute. In this way, where a network attribute satisfies a conditional attribute, the satisfaction of the conditional attribute can act as a confirmation that a reverse engineering task was successfully completed and that a network attribute is associated with malware data in the binary data stream.

At step 212, method 200 can include generating a report based on data extracted and/or collected at each agent node. For example, each agent computing node 116 can generate a report based on performing code analysis on the binary data stream to reverse engineer the binary data stream. Agent computing nodes 116 can generate a report based on the extracted and/or collected data associated with the binary data stream from executing the generate script file. In some embodiments, agent computing nodes 116 can generate a report including the generated script, one or more network attributes, and whether any conditional attributes were satisfied in an iteration of code analysis of the binary data stream. In some embodiments, only a portion of agent computing nodes 116 may generate reports, or at least one agent computing node 116 may generate a report. The collected data can include network attributes, processor trace data, decompiled code, and other information about the binary data stream. In some embodiments, agent computing nodes 116 can transmit the report (or plural reports) to controller node 114 and/or to malware detection node 102.

At step 214, method 200 can include determining that data in the report satisfies a conditional attribute. For example, agent computing nodes 116 and/or malware detection node 102 can determine that the data in the report satisfies at least one conditional attribute.

At step 216, method 200 can include distributing the report to each of the plural agent nodes. For example, at least one agent computing node 116 can transmit the report to each other agent computing node 116 such that each other agent computing node 116 can update its code analysis and reverse engineering of the binary data stream.

At step 218, method 200 can include, iteratively at each agent node, reverse engineering the binary data stream, generating a reverse engineered script file, executing the reverse engineered script file, generating a report based on data collected, determining that data in the report satisfies or does not satisfy a conditional attribute, and distributing the report to each of the plural agent nodes. For example, each agent computing node 116 can iteratively reverse engineering the binary data stream, generate a reverse engineered script file, execute the reverse engineered script file, generate a report based on data collected via the execution of the script file, determine that data in the report satisfies a conditional attribute, and distributing the report to each other agent computing node 116 where the data in the report satisfies at least one conditional attribute. In some embodiments, reverse engineering the binary data stream can include executing a processor trace and/or inputting the binary data stream into a decompiling tool to generate decompiled code output. In some embodiments, iterative reverse engineering of the binary data stream, generating a report, and determining that data in the report satisfies at least one conditional attribute may be performed for a different conditional attribute at each iteration. In some embodiments, iterative reverse engineering of the binary data stream, generating a report, and determining that data in the report satisfies at least one conditional attribute may be performed for the same conditional attribute where the conditional attribute was not satisfied at a previous iteration. Execution of the reverse engineered script file can be performed at each agent computing node 116 such that the at least one conditional attribute associated with a current iteration has been tested at every agent computing node 116 to generate a report indicating whether the at least one conditional attribute has or has not been satisfied.

In some embodiments, agent computing nodes 116 can execute the script file for test execution to validate the conditional attribute. Execution of the script file can satisfy the conditional attribute. Agent computing nodes 116 can transmit the script file to malware detection node 102 and/or store the script file and the conditional attribute in a malware database as the reverse engineered script file for use in malware detection and/or beacon interception.

At step 220, method 200 can include intercepting a malware beacon transmission. For example, malware detection node 102 can intercept a malware beacon transmission within the computer network based on reverse engineering the binary data stream and extracting the data associated with the binary data stream (e.g., network attributes. Once agent computing nodes 116 complete reverse engineering the binary data stream, executing a generated script, and validating conditional attributes, a final generated script and/or network attributes and data associated with the binary data stream can be transmitted to malware detection node 102 from agent computing nodes 116. Malware detection node can then use the final generated script and/or network attributes and data associated with the binary data stream to detect and intercept a malware beacon transmission with the computing network.

In some embodiments, each agent computing node 116 can execute the binary data stream to trace processor instructions. For example, each agent computing node 116 can make API calls to processor trace system 112 while executing the binary data stream (e.g., as compiled binary code) to generate processor trace output representing execution steps and processor instructions of the binary data stream executed by the agent processors. Each agent computing node 116 can generate a processor trace output based on executing the binary data in conjunction with a processor trace API for processor trace system 112. Each agent computing node 116 can generate a different processor trace output using the same binary data stream input.

In some embodiments, each agent computing node 116 can generate decompiled data from the binary data stream using a decompiling application. For example, each agent computing node 116 can use the binary data stream as input to a decompiling application (e.g., Ghidra) to generate decompiled data (e.g., in a form of decompiled source code, or rough decompiled source code). Each agent computing node 116 may generate different decompiled data using the decompiling application and using the same binary data stream as input to the decompiling application.

In some embodiments, the decompiling application can include program code (e.g., an application) for Ghidra. When integrating the processor trace output with the decompiled data, each agent computing node 116 can identify a first offset and a last offset for each of plural functions in the processor trace output. The first offset and last offset may refer to a distance between a reference point in the processor trace output and a location of an instructions for a function. In this way, an offset can describe where in the execution order a certain function was executed and/or called.

In some embodiments, each agent computing node 116 can map each function to output from Ghidra using the first offset and the last offset for each function. For example, each agent computing device 116 can map the functions found in the processor trace output using the first and last offset for each of the plural functions to the decompiled code generated by the decompiling application to generate a function mapping. The function mapping can be used to generate a script which can closely resemble the binary data stream.

In some embodiments, each agent computing node 116 can map the processor trace output with the decompiled data to generate the script file for intercepting a malware beacon transmission. For example, each agent computing node 116 can perform its own independent mapping of processor trace output to decompiled data to construct a script that resemble functional communication aspects and/or functional attributes of the binary data stream. In some embodiments, each agent computing node 116 can perform its own independent mapping of processor trace output to decompiled data to construct a script that can simulate/emulate a component related to the binary data stream (e.g., a command and control server) when the script is executed.

In some embodiments, each agent computing node 116 can execute the script file for test execution to validate the conditional attribute. The script file may not satisfy the at least one conditional attribute for one or more agent computing nodes 116. In this instance, for the agent computing nodes 116 where the scripts does not satisfy the at least one conditional attribute, those agent computing nodes 116 can begin a new iteration to further reverse engineer the binary data and perform another test to attempt to satisfy the at least one conditional attribute.

In some embodiments, controller node 114 can update instructions for each agent computing node 116 for generating the script file. Controller node 114 can transmit, the updated instructions to each agent computing node 116 to cause each agent node to regenerate the script file. For example, controller node 114 can transmit instructions to each agent node 116 to generate a subsequent script file (e.g., in a subsequent iteration) based on the conditional attribute.

Steps of method 200 can be performed in various orders and sequences and are not necessarily limited to being performed in the order shown in FIG. 2. Accordingly, steps of method 200 are not limited to any particular order and can be performed by various components or applications, whether malware detection node 102 is implemented on a single computing device or multiple, distributed computing devices. Steps of method 200 can also be performed by a single processor of malware detection node 102, a single processor of controller node 114, a single processor of agent computing nodes 116, or by multiple processors of various components of computing system 100.

It should be understood that techniques disclosed herein are not limited to any particular type of malware and techniques disclosed herein can be used to reverse engineer and/or intercept transmissions of binary data and/or binary files representing various types of malicious program code (e.g., ransomware, computer viruses, trojan horse, spyware, and/or the like).

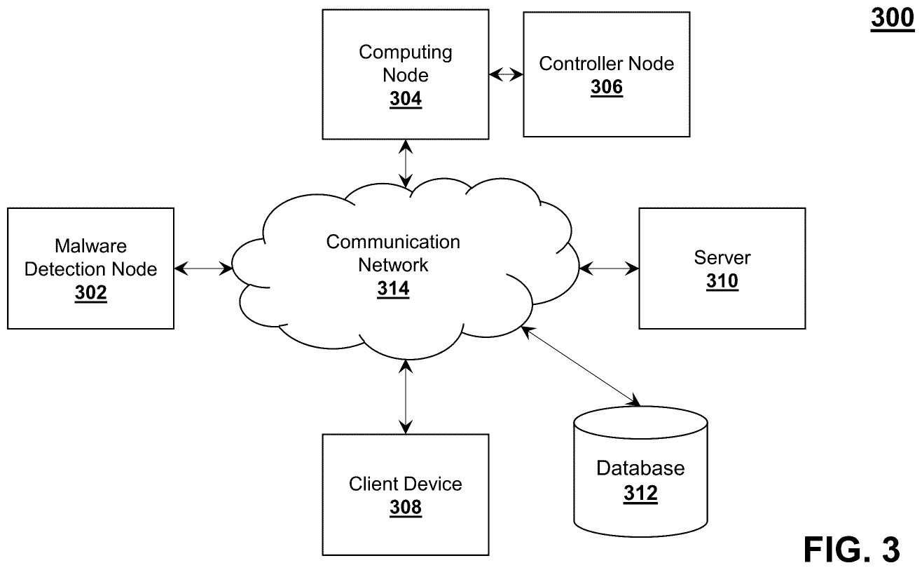

FIG. 3 shows a diagram of an exemplary computing and/or network environment 300 in which methods, systems, and/or computer program products, described herein, can be implemented as disclosed herein. Computing and/or network environment 300 can include malware detection node 302, computing node 304, controller node 306, client device 308, server 310, database 312, and communication network 314. In some embodiments, each of computing node 304, controller node 306, client device 308, server 310, database 312, and/or communication network 314 can be implemented by (e.g., as part of) malware detection node 302. In some embodiments, at least one of each of computing node 304, controller node 306, client device 308, server 310, database 312, and/or communication network 314 can be implemented by (e.g., as part of) another system, another device, another group of systems, or another group of devices, separate from or including malware detection node 302, such as computing node 304, controller node 306, client device 308, server 310, database 312, and/or the like.

Malware detection node 302 can include one or more devices capable of receiving information from and/or communicating information to computing node 304, client device 308, server 310, and/or database 312 via communication network 314. For example, malware detection node 302 can include a computing device, such as a server, a group of servers, and/or other like devices. In some embodiments, malware detection node 302 can be associated with a server as described herein. In some embodiments, malware detection node 302 can be in communication with a data storage device (e.g., database 312, and/or the like), which can be local or remote to malware detection node 302. In some embodiments, malware detection node 302 can be configured to receive information from, storing information in, communicating information to, or searching information stored in the data storage device. In some embodiments, malware detection node 302 can be the same as or similar to computing device 100 and/or malware detection node 102, and other systems or devices that can perform the steps of method 200.

Computing node 304 can include one or more devices, virtual machines, and/or containers capable of receiving information and/or communicating information to malware detection node 302, controller node 306, client device 308, server 310, and/or database 312 via communication network 314. For example, computing node 304 can include a computing device, such as a server, a group of servers, and/or other like devices. Computing node 304 can include a virtual machine or a container executing on a server or other computing device. In some embodiments, computing node 304 can be associated with a server, a client device, and/or a user device as described herein. Computing node 304 can be the same as or similar to agent computing node 116.

Controller node 306 can include one or more devices, virtual machines, and/or containers capable of receiving information and/or communicating information to computing node 304. For example, controller node 306 can include a computing device, such as a server, a group of servers, and/or other like devices. Controller node 306 can include a virtual machine or a container executing on a server or other computing device. In some embodiments, computing node 304 can be associated with a server, a client device, and/or a user device as described herein. In some embodiments, controller node 306 can receive information from and/or communicate information to computing node 304 via a communication network. Controller node 306 can be the same as or similar to controller node 114.

Client device 308 can include one or more devices capable of receiving information from and/or communicating information to malware detection node 302, computing node 304, server 310, and/or database 312 via communication network 312. Additionally or alternatively, one or more client devices 308 can include a device capable of receiving information from and/or communicating information to other client devices 308 via communication network 314, another network (e.g., an ad hoc network, a local network, a private network, a virtual private network, and/or the like), and/or any other suitable communication technique. For example, client device 308 can include a user device and/or the like. In some embodiments, client device 308 can include at least one virtual machine for executing scripts and/or source code files that can contain and/or simulate/emulate malicious program code.

Server 310 (and “server” as used herein) can include one or more computing devices (e.g., one or more computing devices) that are operated by or facilitate communication and processing for multiple parties (e.g., clients, client devices, users, and/or the like) in a network environment (e.g., network environment 300), such as the Internet, although it will be appreciated that communication may be facilitated over one or more public or private network environments (e.g., communication network 314) and that various other arrangements are possible. Further, multiple computing devices (e.g., servers 310, computing nodes 304, etc.) directly or indirectly communicating in the network environment can constitute a “system.” In some embodiments, server 310 can execute and/or operate, processor trace system 112, malware detection application 104 and/or malware detection node 302.

Database 312 can include a computing device (e.g., a database device) configured to communicate with malware detection node 302, computing node 304, client device 308, and/or server 310 via communication network 314. For example, database 312 can include a server, a group of servers, and/or other like devices. In some embodiments, database 312 can be associated with one or more computing devices providing interfaces such that a user can interact with database 312 via the one or more computing devices. Database 312 can be in communication with malware detection node 302 such that database 312 is separate from malware detection node 302. Alternatively, in some embodiments, database 312 can be part of (e.g., a component of) malware detection node 302.

In some embodiments, database 312 can include a device capable of storing data (e.g., a storage device). In some embodiments, database 312 can include a collection of data stored and accessed by one or more computing devices. Database 312 can include file system storage, cloud storage, in-memory storage, and/or the like. Database 312 can include non-volatile storage (e.g., flash memory, magnetic media, and/or the like), volatile storage (e.g., random-access memory and/or the like), or both non-volatile and volatile storage. In some embodiments, database 312 can be part of (e.g., a component of) malware detection node 302.

Communication network 314 can include one or more wired and/or wireless networks. For example, communication network 314 can include a cellular network (e.g., a long-term evolution (LTE®) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with malware detection node 302), an ad hoc network, an intranet, the Internet, a fiber optic-based network, a cloud computing network, and/or the like, and/or a combination of these or other types of networks.

The number and arrangement of systems, devices, and/or networks shown in FIG. 3 are provided as an example. There may be additional systems, devices, and/or networks; fewer systems, devices, and/or networks; different systems, devices, and/or networks; and/or differently arranged systems, devices, and/or networks than those shown in FIG. 3. Furthermore, two or more systems or devices shown in FIG. 3 can be implemented within a single system or device, or a single system or device shown in FIG. 3 can be implemented as multiple, distributed systems or devices. Additionally or alternatively, a set of systems (e.g., one or more systems) or a set of devices (e.g., one or more devices) of environment 300 can perform one or more functions described as being performed by another set of systems or another set of devices of environment 300.

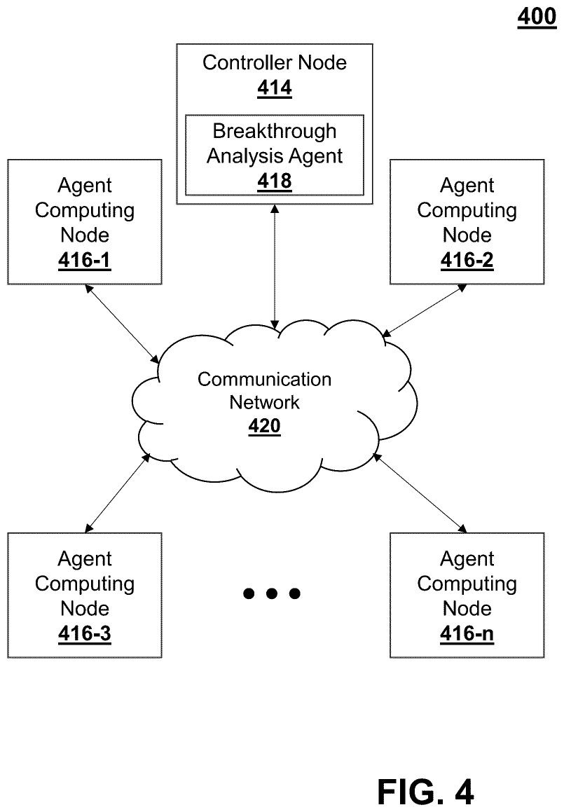

FIG. 4 shows a diagram of an exemplary distributed architecture 400 for reverse engineering binary data as disclosed herein. As shown in FIG. 4, distributed architecture 400 can include controller node 414, agent computing node 416-1 to agent computing node 416-n (referred to individually as agent computing node 416 and collectively as agent computing nodes 416, where appropriate), breakthrough analysis agent 418, and communication network 420. Controller node 414 can communicate with each agent computing node 416 via communication network 420. Each agent computing node 416 can communicate with controller node 414 and each other agent computing node 416 via communication network 420. In some embodiments, controller node 414 may be the same as or similar to controller node 114 described herein and agent computing nodes 416 may be the same as or similar to agent computing nodes 116 described herein. Controller node 414 can include program code for breakthrough analysis agent 418.

Controller node 414 can include breakthrough analysis agent 418 and a controller defined by Neural Autonomic Transport System (NATS). For example, controller node 414 can include program code that, when executed, can cause controller node 414 to facilitate real time message communication among controller node 414 and agent computing nodes 416, including at least publish/subscribe message services, request-reply message services, and message persistence. For example, controller node 414 can provide message persistence such that messages can be stored in case at least one agent computing node 416 fails. Controller node 414 can provide streaming of data (e.g., binary data) to each agent computing node 416. Streaming of data provided by controller node 414 can allow for agent computing nodes 416 to be highly decoupled, such that agent computing nodes 416 do not depend on each other or data from one another. Agent computing nodes 416 could be online or offline at different times depending on available computing resources, and streaming and message persistence of controller node 414 can allow for agent computing nodes 416 to receive data at a later time, when they were offline at an earlier time.

In some embodiments, controller node 414 can store a historical record of the stream data (e.g., a binary data stream). For example, controller node 414 can store a historical record of a data stream for later replaying the data stream to at least one agent computing node 416 for analysis. Controller node 414 can provide streamed data to agent computing nodes 416 at different streaming rates during analysis, such that agent computing nodes 416 can consume and analyze the data at their own pace. This can allow controller node 414 to stream data decoupled between each agent computing node 416, allowing for varying use of computing resources and for agent computing nodes 416 to complete reverse engineering tasks and validation of tasks at different rates, thus taking advantage of efficient breakthroughs from at least one agent computing node 416. Thus, controller 414 can provide a high performance messaging system with low latency and scalability such that reverse engineering tasks can be completed with efficient resource use in an acceptable amount of time.

Agent computing nodes 416 can include either hardware and/or software nodes. For example, agent computing nodes 416 can each include an individual server or multiple servers. In some embodiments, agent computing nodes may collectively include a single server where each agent computing node 416 is represented by a virtual machine or a container executing on the single server, thus sharing physical resources. In some embodiments, agent computing nodes 416 may each include a container executing on hardware, where each agent computing node 416 can be managed by a container management application. In this way, controller node 114 can provide background messaging to agent computing nodes 416 and agent computing nodes can transmit messages to each other (e.g., in a peer-to-peer-fashion) and controller node 414. This message scheme between controller node 414 and agent computing nodes 416 can ensure that messages between the components are delivered promptly and reliably without requiring manual intervention.

In some embodiments, agent computing nodes 416 can be automatically added and removed from distributed architecture 400. For example, where agent computing nodes 416 are virtual machines or containers sharing hardware resources, additional agent computing nodes can be added (e.g., spun up) dynamically when more computing nodes are required for code analysis and reverse engineering binary data. Additionally or alternatively, existing agent computing nodes 416 can be removed and/or terminated (e.g., spun down) when the requirements of code analysis and reverse engineering tasks indicate that less resources are required. In this way, distributed computing system 400 can ensure system resources are managed properly and efficiently when reverse engineering binary data while distributed architecture 400 remains fault-tolerant, being able to handle spinning down of resources that are not needed for current reverse engineering tasks.

Agent computing node 416 can automatically register with controller node 414 when they are introduced (e.g., spun up) in distributed architecture 400. For example, when a new agent computing node 416 is spun up, the new agent computing node 416 can include a unique identifier such that controller node 414 can identify the new agent computing node 416 and can track how long the new agent computing node 416 is online, connected, and/or performing reverse engineering tasks. Agent computing nodes 416 can automatically register with controller node 414 by transmitting a unique identifier to controller node 414. Controller node 414 can maintain an active registry of agent computing nodes 416 such that controller 414 is aware of how many agent computing nodes 416 are currently active and which agent computing nodes 416 are currently active based on a registry of unique identifiers for active agent computing nodes 416.

In some embodiments, agent computing nodes 416 can subscribe to message channels provided by controller node 416 such that agent computing nodes can receive messages only through channel of which they are subscribed. For example, agent computing node 416-1 may subscribe to a first message channel through controller node 414 corresponding to a first binary data stream for reverse engineering. Agent computing node 416-2 may subscribe to a second message channel through controller node 414 corresponding to a second binary data stream for reverse engineering. In this way, different agent computing nodes 416 can analyze different portions of binary data when reverse engineering a binary data stream, such that the code analysis can be distributed to conserve resources, but distributed architecture 400 can allow each agent computing node 416 to share analysis data among each other agent computing node 416, reducing time required for reverse engineering binary data.

In some embodiments, a first channel used by agent computing nodes 416 and/or controller node 414 can include a breakthrough submission message channel (e.g., via a breakthrough.submit channel). The breakthrough submission message channel can be used by agent computing nodes 416 to submit at least one breakthrough to controller node 414 when reverse engineering binary data streams. Agent computing nodes 416 can transmit analysis results (e.g. reports, generated scripts, etc.) and validation data (e.g., network attributes, other collected data and/or metadata, etc.) to controller node 414 via the breakthrough submission message channel.

In some embodiments, a second channel used by agent computing nodes 416 and/or controller node 414 can include a breakthrough validated message channel (e.g., via a breakthrough. validated channel). The breakthrough validated message channel can be used by controller node 414 to distribute a validated breakthrough (e.g., a validated conditional attribute) to each agent computing node 416. Controller 414 can store previously verified breakthrough data, allowing for breakthroughs to be categorized and identified as new breakthroughs. Additionally, verified breakthrough data can be used by controller node 414 in future reverse engineering and code analysis of binary data streams to reduce repeated analysis performed by agent computing nodes 416. Controller node 414 can transmit the verified breakthrough data through the breakthrough validated message cannel to each agent computing node 416 such that each agent computing node 416 can update its own locally stored analysis data with the verified breakthrough data received from controller node 414. The verified breakthrough data can also include an execution context (e.g., data related to execution of the binary data stream and/or generated script, such as data associated with an execution environment). In some embodiments, all agent computing nodes 416 registered with controller node 414 can be subscribed to the breakthrough validated message channel such that all agent computing nodes 416 registered with controller node 414 will receive breakthrough validated messages including verified breakthrough data after the breakthrough validated messages are queued at controller node 414.

In some embodiments, controller node 414 may include program code for breakthrough analysis agent 418. Alternatively, controller node 414 may be separate from breakthrough analysis agent 418 such that controller node 414 and breakthrough analysis agent 418 reside on separate computing devices (e.g., or in separate virtual machines and/or containers). Where controller node 414 includes program code for breakthrough analysis agent 418, controller node 414 can execute the program code for breakthrough analysis agent 418 to validate breakthrough submissions received from at least one agent computing node 416 via the breakthrough submission message channel. For example, breakthrough analysis agent 418 can cause controller node 414 to validate a breakthrough submission, including analysis results and validation data, transmitted by at least one agent computing node 416 by checking the breakthrough submission against current validation requirements for a current task and/or subtask, such as at least one conditional attribute. That is, breakthrough analysis agent 418 can check the breakthrough submission against the at least one conditional attribute to determine that the analysis results and/or validation data satisfy or do not satisfy the at least one conditional attribute. In some embodiments, breakthrough analysis agent 418 can cause controller node 414 to verify quality of the analysis results and/or validation data received in the breakthrough submission. Breakthrough analysis agent 418 can also cause controller node 414 to analyze the analysis results and/or validation data to ensure the breakthrough submission advances a goal defined by text input data. Where breakthrough analysis agent 418 causes controller node 414 to determine that the breakthrough submission satisfies at least one conditional attribute, breakthrough analysis agent 418 can cause controller node 414 to confirm distribution of the breakthrough submission (e.g., as a validated breakthrough including validated data) to each other agent computing node 416 via the breakthrough validated message channel. In some embodiments, breakthrough analysis agent 418 can cause controller node 414 to store and maintain breakthrough history (e.g., by storing analysis results, validated data, and/or verified breakthrough data).

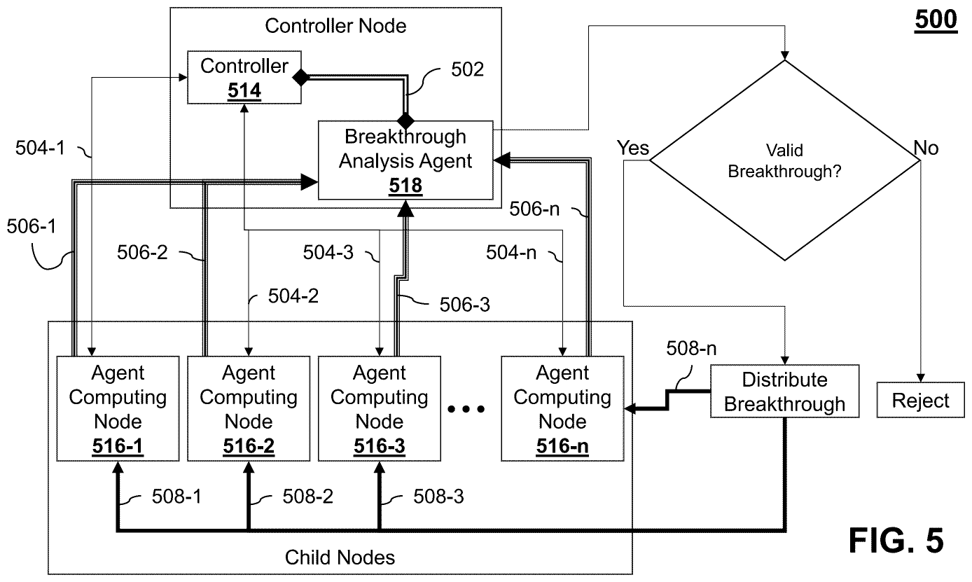

FIG. 5 shows a diagram of an exemplary system components and processing flow 500 for reverse engineering binary data using a distributed network as disclosed herein. As shown in FIG. 5, system components and processing flow 500 can include controller 514, agent computing node 516-1 to agent computing node 516-n (referred to individually as agent computing node 516 and collectively as agent computing nodes 516 where appropriate), breakthrough analysis agent 518, registration channel 502, registration message channel 504 (including registration message 504-1 to registration message 504-n), breakthrough submission message channel 506 (including breakthrough submission message 506-1 to breakthrough submission message 506-n), and breakthrough validated channel 508 (including breakthrough validated message 508-1 to breakthrough validated message 508-n).

Controller 514 can be the same as or similar to controller node 114 and/or controller node 414 as described herein. Controller 514 can be a component of a controller node, as shown in FIG. 5. Controller 514 can be in communication with breakthrough analysis agent 518 via registration channel 502. Controller 514 and breakthrough analysis agent 518 can share various data and commands via registration channel 502, including registration of agent computing nodes 516 via agent computing node identifiers.

Agent computing nodes 516 can be the same as or similar to agent computing nodes 116 and/or agent computing nodes 416 as described herein. Agent computing nodes 516, when introduced and/or generated (e.g., spun up) as a node in system components and processing flow 500, can register with the controller node and controller 514 by transmitting a registration message over registration message channel 504. For example, agent computing node 516-1 can transmit registration message 504-1 including at least a unique identifier for agent computing node 516-1 over registration message channel 504 to register with the controller node. Controller 514 can share the unique identifier for agent computing node 516-1 with breakthrough analysis agent 518 via registration channel 502. Agent computing node 516-2 can transmit registration message 504-2 including at least a unique identifier for agent computing node 516-2 over registration message channel 504 to register with the controller node. Controller 514 can share the unique identifier for agent computing node 516-2 with breakthrough analysis agent 518 via registration channel 502. Agent computing node 516-3 can transmit registration message 504-3 including at least a unique identifier for agent computing node 516-3 over registration message channel 504 to register with the controller node. Controller 514 can share the unique identifier for agent computing node 516-3 with breakthrough analysis agent 518 via registration channel 502. This process may continue for all agent computing nodes 516 that are spun up, up to agent computing node 516-n. Similarly, controller 514 can remove the unique identifiers for agent computing nodes 516 when specific agent computing nodes are terminated (e.g., spun down).

Agent computing nodes 516 can perform breakthrough discovery while reverse engineering binary data by determining that at least one agent computing node 516 made a potential breakthrough in reverse engineering the binary data by comparing analysis results and/or code analysis output (e.g., a generated script) to one or more conditional attributes associated with a goal. In some embodiments, discovery of a potential breakthrough by at least one agent computing node 516 can include a discovery context (e.g., data related to a context of reverse engineering the binary data, such as an execution environment and/or processor trace on the at least one agent computing node 516). Each agent computing node 516, when each agent computing node 516 has made a discovery of a potential breakthrough, can submit breakthrough data (e.g., analysis results and/or output) via breakthrough submission message channel 506. For example, agent computing node 516-1, where agent computing node 516-1 has discovered a potential breakthrough, can submit breakthrough data via breakthrough submission message 506-1 to breakthrough analysis agent 518. Where agent computing node 516-2 has discovered a potential breakthrough, agent computing node 516-2 can submit breakthrough data via breakthrough submission message 506-2 to breakthrough analysis agent 518. Where agent computing node 516-3 has discovered a potential breakthrough, agent computing node 516-3 can submit breakthrough data via breakthrough submission message 506-3 to breakthrough analysis agent 518. This process may continue for all agent computing nodes 516 that are active, up to agent computing node 516-n. Similarly, breakthrough analysis agent 518 and/or controller 514 can receive and analyze the breakthrough data for validation.

Breakthrough analysis agent 518 can receive the breakthrough data from each agent computing node 516 via breakthrough submission message channel 506 for validating the breakthrough data. For example, breakthrough analysis agent 518 can analyze the breakthrough data against current task and/or subtask criteria (e.g., against at least one conditional attribute relating to reverse engineering the binary data). If breakthrough analysis agent 518 determines that the breakthrough data satisfies current task and/or subtask criteria, then breakthrough analysis agent can determine that the breakthrough data is valid and requires distribution to other agent computing nodes 516. In some embodiments, breakthrough analysis agent 518 can check with controller 514 to determine if the received breakthrough data is redundant and has already been received and/or analyzed and validated. In this instance, breakthrough analysis agent 518 can forgo analysis of breakthrough data that is determined to be redundant.

Typically, breakthrough analysis agent may only receive breakthrough data from one agent computing node 516 at a time for validation and distribution to other agent computing nodes 516. However, it should be understood that it is possible for breakthrough analysis agent to receive multiple sets of breakthrough data from multiple agent computing nodes 516 at one time. In this instance, breakthrough analysis agent 518 can queue the received breakthrough data for validation.

When breakthrough analysis agent 518 determines that the received breakthrough data is valid, controller 514 and/or breakthrough analysis agent 518 can publish validated breakthrough data via breakthrough validated channel 508. For example, where breakthrough analysis agent 518 determines that breakthrough data received from at least one agent computing node 516 is valid, breakthrough analysis agent 518 can determine to distribute the breakthrough data by publishing the validated breakthrough data to breakthrough validated channel 508 such that each agent computing node 516 subscribed to breakthrough validated channel 508 can receive the breakthrough data via breakthrough validated messages 508-1, 508-2, 508-3, to 508-n for all agent computing nodes 516. Once agent computing nodes 516 receive the validated breakthrough data, each agent computing node 516 can update its data associated with reverse engineering the binary data to incorporate the breakthrough data, such that the breakthrough data is shared among active agent computing nodes 516 subscribed to breakthrough validated channel 508. In some embodiments, all agent computing nodes 516 registered with controller 514 can receive the breakthrough data via breakthrough validated channel 508, without being subscribed to the breakthrough validated channel 508. This can ensure all active agent computing nodes 516 receive the breakthrough data for progressing in reverse engineering the binary data and satisfying existing tasks and/or subtasks. In this way, agent computing nodes can make breakthroughs in reverse engineering the binary data independently and share the breakthroughs via a gossip protocol among all agent computing nodes such that reverse engineering the binary data is accomplished automatically, with reduced time and minimal computing resources.

In some embodiments, breakthrough analysis agent 518 can adjust analysis paths and can prioritize which tasks and/or subtasks to solve for next at each agent computing node 516 to generate a subsequent breakthrough. Breakthrough analysis agent 518 can prioritize analysis based on which tasks may be faster for reverse engineering the binary data and/or which tasks can result in more efficient reverse engineering.

Embodiments including system components and processing flow 500 disclosed herein can result in simple and efficient distribution of breakthroughs and data for reverse engineering binary data. Additionally, embodiments can provide real-time breakthrough sharing among agent computing nodes with centralized validation to ensure quality of breakthroughs and analysis data generated at agent computing nodes. Embodiments including system components and processing flow 500 can provide a scalable architecture with low overhead and reduced computing resource requirements by dynamically spinning up and spinning down agent computing nodes where processing power requires it. It should be understood that system components and processing flow 500 can be applied to any embodiments disclosed herein, including computing system 100 (e.g., controller node 114 and agent computing nodes 116).

Embodiments described herein can thus leverage parallel analysis effort among agent computing nodes while reducing any redundant work of reverse engineering binary data. System components and processing flow 500 can accelerate goal completion and thus accelerate reverse engineering of binary data. The centralized system with distributed agent computing nodes can maintain analysis quality while enabling collaborative, parallel progress among agent computing nodes. Additionally, embodiments disclosed herein can support non-deterministic LLM analysis.

The number and arrangement of systems, hardware, and/or applications shown in FIG. 5 is provided as an example. There may be additional systems, hardware, and/or applications, fewer systems, hardware, and/or applications, different systems, hardware, and/or applications, or differently arranged systems, hardware, and/or applications than those shown in FIG. 5. Furthermore, two or more systems, hardware, and/or applications shown in FIG. 5 can be implemented within a single system, hardware, and/or device. A single system, hardware, and/or applications shown in FIG. 5 can be implemented as multiple, distributed systems, hardware, and/or applications. Additionally, or alternatively, a set of systems, a set of hardware, and/or a set of applications of FIG. 5 can perform one or more functions described as being performed by another set of systems, another set of hardware, or another set of applications of FIG. 5.

Any of the processors disclosed herein can include any integrated circuit or other electronic device (or collection of devices) capable of performing an operation on at least one instruction, which can include a Reduced Instruction Set Core (RISC) processor, a CISC microprocessor, a Microcontroller Unit (MCU), a CISC-based CPU, a DSP, a GPU, a Field Programmable Gate Array (FPGA), etc. The hardware of such devices can be integrated onto a single substrate (e.g., silicon “die”), or distributed among two or more substrates. Various functional aspects of the processor can be implemented solely as software or firmware associated with the processor.

The processor can include one or more processing or operating modules. A processing or operating module can be a software or firmware operating module configured to implement any of the functions disclosed herein. The processing or operating module can be embodied as software and stored in memory; the memory being operatively associated with the processor. A processing module can be embodied as a web application, a desktop application, a console application, etc.

The processor can include or be associated with a computer or machine readable medium. The computer or machine readable medium can include memory. Any of the memory discussed herein can be computer readable memory configured to store data. The memory can include a volatile or non-volatile, transitory or non-transitory memory, and be embodied as an in-memory, an active memory, a cloud memory, etc. Examples of memory can include flash memory, RAM, ROM, Programmable Read only Memory (PROM), Erasable Programmable Read only Memory (EPROM), Electronically Erasable Programmable Read only Memory (EEPROM), FLASH-EPROM, Compact Disc (CD)-ROM, Digital Optical Disc DVD), optical storage, optical medium, a carrier wave, magnetic cassettes, magnetic tape, magnetic disk storage or other magnetic storage devices, or any other medium which can be used to store the desired information and which can be accessed by the processor.

The memory can be a non-transitory computer-readable medium. The term “computer-readable medium” (or “machine-readable medium”) as used herein is an extensible term that refers to any medium or any memory, that participates in providing instructions to the processor for execution, or any mechanism for storing or transmitting information in a form readable by a machine (e.g., a computer). Such a medium can store computer-executable instructions to be executed by a processing element and/or control logic, and data which is manipulated by a processing element and/or control logic, and can take many forms, including but not limited to, non-volatile medium, volatile medium, transmission media, etc. The computer or machine readable medium can be configured to store one or more instructions thereon. The instructions can be in the form of algorithms, program logic, etc. that cause the processor to execute any of the functions disclosed herein.

Embodiments of the memory can include a processor module and other circuitry to allow for the transfer of data to and from the memory, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc. Communications can be via Bluetooth, near field communications, cellular communications, telemetry communications, Internet communications, etc.

Data stored in the exemplary computing device (e.g., in the memory) can be stored on any type of suitable computer readable media, such as optical storage (e.g., a compact disc, digital versatile disc, Blu-ray disc, etc.), magnetic tape storage (e.g., a hard disk drive), or solid-state drive. An operating system can also be stored in the memory.

In an exemplary embodiment, the data can be configured in any type of suitable database configuration, such as a relational database, a structured query language (SQL) database, a distributed database, an object database, etc. Suitable configurations and storage types will be apparent to persons having skill in the relevant art.

The exemplary computing device can also include a communications interface. The communications interface can be configured to allow software and data to be transferred between the computing device and external devices. Exemplary communications interfaces can include a modem, a network interface (e.g., an Ethernet card), a communications port, a PCMCIA slot and card, etc. Software and data transferred via the communications interface can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, etc. Transmission of data and signals can be via transmission media. Transmission media can include coaxial cables, copper wire, fiber optics, etc. Transmission media can also take the form of acoustic or light waves, such as those generated during radio-wave and infrared data communications, or other form of propagated signals (e.g., carrier waves, digital signals, etc.).

Memory semiconductors (e.g., DRAMs, etc.) can be means for providing software to the computing device. Computer programs (e.g., computer control logic) can be stored in the memory. Computer programs can also be received via the communications interface. Such computer programs, when executed, can enable computing device to implement the present methods as discussed herein. In particular, the computer programs stored on a non-transitory computer-readable medium, when executed, can enable hardware processor device to implement the methods as discussed herein. Accordingly, such computer programs can represent controllers of the computing device.

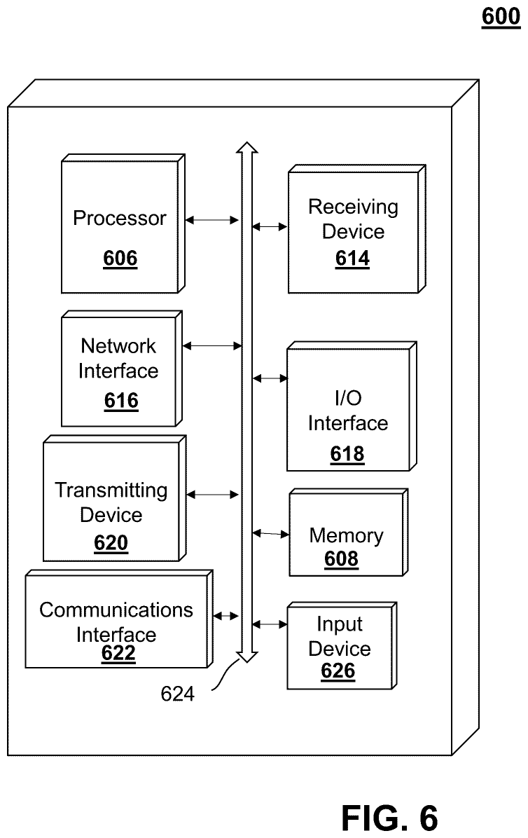

FIG. 6 shows a diagram of example components of a computing device or system 600 as disclosed herein. Computing device 600 (and/or at least one component of computing device 600) can correspond to at least one of malware detection node 102, malware detection application 104, processor 106, memory 108, decompiled code database 110, processor trace system 112, controller node 114, and/or agent computing nodes 116 in FIG. 1 and/or at least one of malware detection node 302, computing device 304, controller node 306, client device 308, server 310, database 312, and/or communication network 314 in FIG. 3. In some embodiments, such systems or devices shown in FIGS. 1 and 3-5 can include at least one computing device 600 and/or at least one component of computing device 600. The number and arrangement of components shown in FIG. 6 are provided as an example. In some embodiments, computing device 600 can include additional components, fewer components, different components, or differently arranged components than those shown in FIG. 6. Additionally, or alternatively, a set of components (e.g., one or more components) of computing device 600 can perform one or more functions described as being performed by another set of components of computing device 600.

Computing system or device 600 can include processor 606, memory 608, receiving device 614, network interface 616, input/output (I/O) interface 618, transmitting device 620, communications interface 622, communication infrastructure 624, and input device 626. Memory 608 can be the same as or similar to memory 108 as disclosed herein. Processor 606 can be the same as or similar to processor 106 as disclosed herein. Communications infrastructure 624 can be the same as or similar to communication network 314.

Memory 608 can be configured for storing program code for at least one machine learning model (e.g., an LLM). Memory 608 can include one or more memory devices such as volatile or non-volatile memory. For example, the volatile memory can include random access memory. According to exemplary embodiments, the non-volatile memory can include one or more resident hardware components such as a hard disk drive and a removable storage drive (e.g., a floppy disk drive, a magnetic tape drive, an optical disk drive, a flash memory, or any other suitable device). The non-volatile memory can include an external memory device connected to communicate with the system 600 via a mobile communication network. According to an exemplary embodiment, an external memory device can be used in place of any resident memory devices. Data stored in system 600 can be stored on any type of suitable computer readable media, such as optical storage (e.g., a compact disc, digital versatile disc, Blu-ray disc, etc.) or magnetic tape storage (e.g., a hard disk drive). The stored data can include network traffic data, log data, streaming events, and/or call detail records (CDRs) generated and/or accessed by processor 606, and software or program code used by processor 606 for performing the tasks associated with the exemplary embodiments described herein. The data can be configured in any type of suitable database configuration, such as a relational database, a structured query language (SQL) database, a distributed database, an object database, etc. Suitable configurations and storage types will be apparent to persons having skill in the relevant art.

Receiving device 614 can be a combination of hardware and software components configured to receive data samples from the mobile network or database. According to exemplary embodiments, receiving device 614 can include a hardware component such as an antenna, a network interface (e.g., an Ethernet card), a communications port, a Personal Computer Memory Card International Association (PCMCIA) slot and card, 5G New Radio (NR) interface, or any other component or device suitable for use on a mobile communication network or Radio Access Network as desired. Receiving device 614 can be an input device for receiving signals and/or data samples formatted according to 3GPP protocols and/or standards. Receiving device 614 can be connected to other devices via a wired or wireless network or via a wired or wireless direct link or peer-to-peer connection without an intermediate device or access point. The hardware and software components of receiving device 614 can be configured to receive the data from the mobile network according to one or more communication protocols and data formats. For example, receiving device 614 can be configured to communicate over a network, which can include a LAN, a WAN, a wireless network (e.g., Wi-Fi), a mobile communication network, a satellite network, the Internet, fiber optic cable, coaxial cable, infrared, radio frequency (RF), another suitable communication medium as desired, or any combination thereof. During a receive operation, receiving device 614 can be configured to identify parts of the received data via a header and parse the data signal and/or data packet into small frames (e.g., bytes, words) or segments for further processing at processor 606.

Processor 606 can be configured for executing the program code stored in memory 608. Upon execution, the program code can cause processor 606 to perform the functions on at least one node within the mobile communication network and/or a remote computing device (e.g., server, computer, etc.) within the mobile communications network according to exemplary embodiments described herein. Processor 606 can be a special purpose computing device encoded with program code, software, and/or firmware or a general purpose computing device configured to read program code or software from memory 608 to execute the program code or software for performing the exemplary functions and/or features disclosed herein. According to exemplary embodiments of the present disclosure, processor 606 can include a CPU. The CPU can be connected to the communications infrastructure including a bus, message queue, network, or multi-core message-passing scheme, for communicating with other components of computing system 600, such as memory 608, input device 626, communications interface 622, and I/O interface 618. The CPU can include one or more processors such as a microprocessor, microcomputer, programmable logic unit or any other suitable hardware computing devices as desired.

I/O interface 618 can be configured to receive a signal from processor 606 and generate an output suitable for a peripheral device via a direct wired or wireless link. I/O interface 618 can include a combination of hardware and software for example, a processor, circuit card, or any other suitable hardware device encoded with program code, software, and/or firmware for communicating with a peripheral device such as a display device, printer, audio output device, or other suitable electronic device or output type as desired.

Transmitting device 620 can be configured to receive data from processor 606 and assemble the data into a data signal and/or data packets according to the specified communication protocol and data format of a peripheral device or remote device to which the data is to be sent. Transmitting device 620 can include any one or more of hardware and software components for generating and communicating the data signal over communications infrastructure 624 and/or via a direct wired or wireless link to a peripheral or remote device. Transmitting device 620 can be configured to transmit information according to one or more communication protocols and data formats as discussed in connection with receiving device 614.

According to exemplary embodiments described herein, memory 608 and processor 606 can store and/or execute computer program code for performing the specialized functions described herein. It should be understood that the program code can be stored on a non-transitory computer usable medium, such as memory devices for the system 600 (e.g., computing device), which can be memory semiconductors (e.g., DRAMs, etc.) or other tangible non-transitory means for providing software to system 600. The computer programs (e.g., computer control logic) or software can be stored in memory devices (e.g., device memory 608) resident on/in system 600. The computer programs can also be received from external storage devices and/or network storage locations via a communications interface. Such computer programs, when executed, can enable system 600 to implement the present methods and exemplary embodiments discussed herein. Accordingly, such computer programs can represent controllers of system 600. Where the present disclosure is implemented using software, the software can be stored in a computer program product or non-transitory computer readable medium and loaded into system 600 using any one or combination of a removable storage drive, an interface for internal or external communication, and a hard disk drive, where applicable.

In the context of exemplary embodiments, a processor can include one or more modules or engines configured to perform the functions of the exemplary embodiments described herein. Each of the modules or engines can be implemented using hardware and, in some instances, can also utilize software, such as corresponding to program code and/or programs stored in memory. In such instances, program code can be interpreted or compiled by the respective processors (e.g., by a compiling module or engine) prior to execution. For example, the program code can be source code written in a programming language that is translated into a lower level language, such as assembly language or machine code (e.g., binary data), for execution by the one or more processors and/or any additional hardware components. The process of compiling can include the use of lexical analysis, preprocessing, parsing, semantic analysis, syntax-directed translation, code generation, code optimization, and any other techniques that can be suitable for translation of program code into a lower level language suitable for controlling system 600 to perform the functions disclosed herein. In some embodiments, pre-compiled program code (e.g., binary data) can be executed by a processor that did not compile the binary data. In such embodiments, the pre-compiled program code can be malicious program code. It will be apparent to persons having skill in the relevant art that such processes result in system 600 being a specially configured computing device uniquely programmed to perform the functions of the exemplary embodiments described herein.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning and range and equivalence thereof are intended to be embraced therein.

What is claimed is:

1. A system for detecting malware in a computer network, comprising:
plural agent computing nodes each including an agent processor in communication with an agent memory storing program code for an adaptive reverse engineering application;
a controller node including a controller processor executing program code for controlling the plural agent computing nodes and for synchronizing the plural agent computing nodes for reverse engineering binary data; and
a malware detection node including:
a processor configured to communicate with memory and execute program code for a malware detection application, wherein the program code for the malware detection application, when executed, will cause the processor to:
receive a binary data stream and text data input, wherein the text data input defines at least one conditional attribute for reverse engineering the binary data;
distribute the binary data and the at least one conditional attribute to each of the plural agent computing nodes;
wherein the program code for the adaptive reverse engineering application on each of the plural agent nodes, when executed by the agent processors, will cause the agent processors to:
generate a source code file based on reverse engineering the binary data stream;
wherein the program code for controlling the plural agent computing nodes, when executed by the controller processor, will cause the controller node to:
determine that a first source code file generated by a first agent processor, when executed by the first agent processor on a first agent computing node, satisfies the at least one conditional attribute to generate a validated attribute;
share the first source code file and the validated attribute with each of the other plural agent nodes and the controller node.

2. The system of claim 1, wherein the program code for the malware detection application, when executed, will cause the processor to:
identify a malware beacon identifier using the first source code file;
store the malware beacon identifier in the malware database; and
intercept a malware beacon transmission within the computer network by identifying the malware beacon transmission based on the malware beacon identifier.

3. The system of claim 1, in combination with a processor trace system, wherein the program code for the malware detection application, when executed, will cause the processor to direct each agent processor on each of the plural agent nodes to execute a processor trace on the binary data stream;
wherein the program code for the adaptive reverse engineering application on the plural agent nodes, when executed by the agent processors, will cause the agent processors to:
transmit an application programming interface (API) request to the processor trace system to execute a processor trace on the binary data stream;
dump processor trace data to each agent memory;
map the processor trace data to decompiled code data from a decompiled code database to generate the source code file based on reverse engineering the binary data stream.

4. The system of claim 1, wherein the program code for the malware detection application, when executed, will cause the processor to:
execute the source code file to identify the malware beacon in the source code file based on the malware beacon being embedded in the binary data stream; and
store beacon identifier data for the beacon transmission and a cryptographic key associated with an encrypted data transmission in a malware database for detection of the malware beacon within the computer network.

5. The system of claim 1, wherein the program code for the malware detection application, when executed, will cause the processor to:
generate decompiled program code based on the binary data stream, wherein the binary data stream is compiled program code;
identify a first offset and a last offset for each of plural functions in the processor trace data; and
correlate the first offset and the last offset of each of the plural functions to the decompiled program code.

6. A method for detecting malware in a computer network, the method comprising:
receiving a binary data stream of binary data representing a malware file at a controller node;
transmitting the binary data stream to plural agent nodes in communication with the controller node;
automatically reverse engineering the binary data stream at each agent node of the plural agent nodes to collect data about the binary data stream among the plural agent nodes;
generating a reverse engineered script file at each agent node based on reverse engineering the binary data stream;
executing the reverse engineered script file to extract data associated with the binary data stream;
generating a report for the binary data stream at each agent node based on the extracted data;
determining, at a controller node, that the report satisfies a conditional attribute;
distributing the report to each of the plural agent nodes to update the collected data about the binary data stream such that the collected data at each agent node satisfies the conditional attribute; and
intercept a malware beacon transmission within the computer network.

7. The method of claim 6, including:
generating the conditional attribute representing validation criteria for a task to be satisfied, wherein the conditional attribute is generated based on text input data provided to a large language model (LLM);
executing the script file for test execution to validate the conditional attribute, wherein the script file satisfies the conditional attribute when executed; and
storing the script file and the conditional attribute in a malware database as the reverse engineered script file for use in malware detection and/or beacon interception.

8. The method of claim 6, including:
executing, with each agent node, the binary data stream to trace processor instructions;
generating, with each agent node, a processor trace output based on executing the binary data in conjunction with a processor trace application programming interface (API);
generating decompiled data from the binary data stream using a decompiling application; and
mapping, with each agent node, the processor trace output with the decompiled data to generate the script file for intercepting a malware beacon transmission.

9. The method of claim 6, including:
executing, with each agent node, the script file for test execution to validate the conditional attribute, wherein the script file does not satisfy the conditional attribute; and
updating instructions, with the controller node, for generating the script file based on the conditional attribute; and
transmitting, with the controller node, the instructions to each agent node to cause each agent node to regenerate the script file.

10. The method of claim 8, wherein the decompiling application includes program code for Ghidra; and
wherein integrating the processor trace output with the decompiled data includes:
identifying a first offset and a last offset for each of plural functions in the processor trace output;
mapping each function to output from Ghidra using the first offset and the last offset for each function.

11. The method of claim 7, wherein the conditional attribute is generated by the LLM based on text input defining the validation criteria for a task.

12. A system for detecting malware in a computer network, comprising:
a memory storing program code for a reverse engineering application;
a database storing conditional attributes defining successful decompiling of binary program code; and
plural agent nodes each including an agent processor and an agent memory storing program code for an agent reverse engineering application;
a controller node in communication with the plural agent nodes; and
a malware detection node including a processor for decompiling binary program code configured to communicate with the memory storing program code for the reverse engineering application, wherein the program code for the reverse engineering application, when executed, will cause the processor to:
receive a binary file including binary program code;
receive text input data which defines a goal of reverse engineering the binary file;
automatically decompose the text input data into one or more conditional attributes for validating a task associated with reverse engineering the binary file;
transmit the binary file and the one or more conditional attributes to each agent node;
receive and execute a final validated source code file to intercept a malware beacon transmission within the computing system;
wherein the program code for the agent reverse engineering application on each agent node, when executed, will cause each agent processor to iteratively:
generate a processor trace output by executing the binary file while tracing instructions of the processor;
map the processor trace output to decompiled code output to generate a source code file based on the binary file;
determine a validated source code file such that the source code file satisfies at least one conditional attribute of the one or more conditional attributes;
wherein program code for the controller node, when executed, will cause the controller node to:
transmit the validated source code file to each of the agent nodes to update the source code file to a validated source code file on each agent node;
terminate iterative execution of each agent reverse engineering application to generate the final validated source code file based on determining that all of the one or more conditional attributes are satisfied; and
cause an agent node to transmit the final validated source code file to the malware detection node for intercepting a malware beacon transmission.

13. The system of claim 12, wherein tracing the instructions of the agent processor includes calling an application programming interface (API) for executing a processor trace.

14. The system of claim 12, wherein the program code for the reverse engineering application, when executed, will cause the processor to store the final validated source code file in the database for intercepting a beacon transmission.

15. The system of claim 12, wherein the binary file including binary program code includes program code for malware.

16. The system of claim 12, wherein the source code file includes program code for a command and control server.

17. The system of claim 12, wherein when the program code for the agent reverse engineering application causes at least one agent processor to transmit the validated source code file to each of the agent nodes to update the source code file to a validated source code file on each agent node, the program code for the agent reverse engineering application will cause the processor to:
synchronize the conditional attribute and the validated source code file on each agent node; and
begin a new iteration to generate the processor trace output by executing the binary file while tracing instructions of the agent processor, based on additional conditional attributes that have not been satisfied by the validated source code file.

18. The system of claim 12, wherein when the program code for the agent reverse engineering application on each agent node causes each agent processor to iteratively map the processor trace output to the decompiled code output to generate the source code file, the program code for the agent reverse engineering application on each agent node will cause the agent processor to:
identify a first offset and a last offset for each of plural functions in the processor trace output; and
correlate each function to the decompiled code output using the first offset and the last offset for each function.

19. The system of claim 12, wherein the decompiled code output is stored in a decompiled code database.

20. The system of claim 12, wherein the plural agent nodes are peer-to-peer nodes in communication with one another.
